(19) United States
(12) Patent Application Publication
(10) Pub. No.: US 2026/0287953 A1
(43) Pub. Date: Sep. 24, 2026

(54) DISPLAY DEVICE

(71) Applicant: Sharp Display Technology Corporation, Kameyama City (JP)

(72) Inventors: Masahiro DATE, Kameyama City (JP); Hiroto AKIYAMA, Kameyama City (JP)

(21) Appl. No.: 19/566,149

(22) Filed: Mar. 13, 2026

(30) Foreign Application Priority Data
Mar. 18, 2025 (JP) 2025-043364

(51) Int. Cl. G02F 1/1362

(52) U.S. Cl. CPC G02F 1/136286

(57) ABSTRACT

A display device includes a first substrate, a second substrate, a first spacer provided on the first substrate, a first wiring line provided on the second substrate and formed from a portion of a first conductive film, a first insulating film provided on the second substrate and disposed on an upper layer side of the first conductive film, and a second wiring line provided on the second substrate and formed from a portion of a second conductive film disposed on an upper layer side of the first insulating film, in which the first insulating film includes a low level portion including a first upper face, and a first high level portion protruding from the first upper face toward the first substrate and including a second upper face higher than the first upper face, the first high level portion overlaps the first spacer and overlaps a portion of the first wiring line, and the second wiring line includes an overlapping portion overlapping a portion of the first wiring line that does not overlap the second upper face, and a non-overlapping portion that is disposed to bypass the first high level portion and does not overlap the second upper face.

### CROSS-REFERENCE TO RELATED APPLICATIONS

This application claims the benefit of priority to Japanese Patent Application Number 2025-043364 filed on Mar. 18, 2025. The entire contents of the above-identified application are hereby incorporated by reference.

### BACKGROUND

### Technical Field

The technique disclosed in the present specification relates to a display device having a large number of second wiring lines installed.

In the related art, an example of a display device is known, which is described in JP 2023-131959 A. The display device described in JP 2023-131959 A includes an array substrate, a counter substrate, a first pixel electrode, a second pixel electrode disposed at a distance from the first pixel electrode in a first direction, a third pixel electrode disposed at a distance from the second pixel electrode in the first direction, a first wiring line located between the first pixel electrode and the second pixel electrode and extending in a second direction intersecting the first direction, a second pixel electrode row including the second pixel electrode and consisting of a plurality of pixel electrodes arranged in the second direction, a third pixel electrode row including the third pixel electrode and consisting of a plurality of pixel electrodes arranged in the second direction, a first insulating film disposed on a lower layer side of the first wiring line, and a spacer protruding from the counter substrate toward the array substrate, in which the spacer is located between the second pixel electrode row and the third pixel electrode row, and a flattening film is configured with a portion overlapping the spacer formed as a high level portion which is higher than the remaining portions.

### SUMMARY

According to the display device described in JP 2023-131959 A, the spacer and the high level portion are in a non-overlapping relationship with the first wiring line, which makes it possible to prevent unevenness caused by the first wiring line from being generated at portions of the inner face of the array substrate that overlap the high level portion. However, in the display device described in JP 2023-131959 A, the first wiring line cannot be disposed at a position overlapping the spacer and the high level portion. For this reason, in a case where it is necessary to increase the number of first wiring lines that can be installed, it has been difficult to address the situation.

The technique described in the present specification was developed on the basis of the above circumstances, and aims to increase the number of second wiring lines that can be installed.
(1) According to the technique described in the present specification, there is provided a display device including: a first substrate; a second substrate facing the first substrate with an interval between the second substrate and the first substrate; a first spacer provided on the first substrate and protruding from the first substrate toward the second substrate; a first wiring line provided on the second substrate and formed from a portion of a first conductive film; a first insulating film provided on the second substrate and disposed on an upper layer side of the first conductive film; and a second wiring line provided on the second substrate and formed from a portion of a second conductive film disposed on an upper layer side of the first insulating film, wherein the first insulating film includes a low level portion including a first upper face as an upper face of the low level portion, and a first high level portion protruding from the first upper face toward the first substrate and including a second upper face higher than the first upper face as an upper face of the first high level portion, the first high level portion is disposed overlapping the first spacer and overlapping a portion of the first wiring line, and the second wiring line includes an overlapping portion overlapping a portion of the first wiring line that does not overlap the second upper face, and a non-overlapping portion that is continuous with the overlapping portion and is disposed bypassing the first high level portion and not overlapping the second upper face.
(2) In addition to the above (1), in the display device, the non-overlapping portion may extend along an outward shape of the first high level portion.
(3) In addition to the above (1) or (2), in the display device, the non-overlapping portion may be disposed on the first upper face of the low level portion.
(4) According to the technique described in the present specification, there is provided a display device including: a first substrate; a second substrate facing the first substrate with an interval between the second substrate and the first substrate; a first spacer provided on the first substrate and protruding from the first substrate toward the second substrate; a first wiring line provided on the second substrate and formed from a portion of a first conductive film; a first insulating film provided on the second substrate and disposed on an upper layer side of the first conductive film; and a second wiring line provided on the second substrate and including a portion formed from a portion of a second conductive film disposed on an upper layer side of the first insulating film and a portion formed from a portion of the first conductive film, wherein the first insulating film includes a low level portion including a first upper face as an upper face of the low level portion, and a first high level portion protruding from the first upper face toward the first substrate and including a second upper face higher than the first upper face as an upper face of the first high level portion, the first high level portion is disposed overlapping the first spacer and overlapping a portion of the first wiring line, the second wiring line includes an overlapping portion formed from a portion of the second conductive film and overlapping a portion of the first wiring line that does not overlap the second upper face, a lead-out portion formed from a portion of the second conductive film, led out from the overlapping portion, and disposed at a position that does not overlap the first wiring line and the second upper face, and a connection portion formed from a portion of the first conductive film and disposed overlapping a portion of the lead-out portion, and a contact hole connecting the lead-out portion and the connection portion is provided at a position overlapping both the lead-out portion and the connection portion within the first insulating film.
(5) In addition to the above (4), in the display device, the connection portion may be disposed bypassing the first high level portion and not overlapping the second upper face.
(6) According to the technique described in the present specification, there is provided a display device including: a first substrate; a second substrate facing the first substrate with an interval between the second substrate and the first substrate; a first spacer provided on the first substrate and protruding from the first substrate toward the second substrate; a first wiring line provided on the second substrate and formed from a portion of a first conductive film; a first insulating film provided on the second substrate and disposed on an upper layer side of the first conductive film; and a second wiring line provided on the second substrate and formed from a portion of a second conductive film disposed on an upper layer side of the first insulating film, wherein the first insulating film includes a low level portion including a first upper face as an upper face of the low level portion, and a first high level portion protruding from the first upper face toward the first substrate and including a second upper face higher than the first upper face as an upper face of the first high level portion, the first high level portion is disposed overlapping the first spacer and overlapping a portion of the first wiring line, and the second wiring line includes an overlapping portion overlapping a portion of the first wiring line that does not overlap the second upper face, and a covering portion that is continuous with the overlapping portion and covers the second upper face.
(7) In addition to any of the above (1) to (6), the display device may further include a second spacer provided on the first substrate and protruding from the first substrate toward the second substrate, wherein the second spacer may have a smaller projection dimension from the first substrate than the first spacer, the first insulating film may include a second high level portion that protrudes from the first upper face toward the first substrate and includes a third upper face as an upper face of the second high level portion, the third upper face being higher than the first upper face and at the same height as the second upper face or lower than the second upper face, the second high level portion may overlap the second spacer and overlap a portion of the first wiring line, and a portion of a surface of the first substrate facing the second substrate that overlaps the first spacer may contact a portion of a surface of the second substrate facing the first substrate that overlaps the first high level portion.

According to the technique described in the present specification, it is possible to increase the number of second wiring lines that can be installed.

### BRIEF DESCRIPTION OF DRAWINGS

The disclosure will be described with reference to the accompanying drawings, wherein like numbers reference like elements.

FIG. 1 is a plan view of a liquid crystal panel, a flexible substrate, and a control substrate according to a first embodiment.

FIG. 2 is a cross-sectional view of the liquid crystal panel, the flexible substrate, and the control substrate according to the first embodiment.

FIG. 3 is a plan view illustrating a pixel arrangement in a display region on an array substrate provided in the liquid crystal panel according to the first embodiment.

FIG. 4 is a plan view illustrating a pixel arrangement of a counter substrate provided in the liquid crystal panel according to the first embodiment.

FIG. 5 is a cross-sectional view taken along line v-v in FIG. 3 in the liquid crystal panel according to the first embodiment.

FIG. 6 is a cross-sectional view taken along line vi-vi in FIG. 3 in the liquid crystal panel according to the first embodiment.

FIG. 7 is a cross-sectional view taken along line vii-vii in FIG. 3 in the liquid crystal panel according to the first embodiment.

FIG. 8 is an enlarged plan view of the vicinity of a first high level portion of the array substrate according to the first embodiment.

FIG. 9 is an enlarged plan view of the vicinity of a first high level portion of an array substrate according to a second embodiment.

FIG. 10 is a cross-sectional view taken along line x-x in FIG. 9 in a liquid crystal panel according to the second embodiment.

FIG. 11 is a cross-sectional view taken along line xi-xi in FIG. 9 in the liquid crystal panel according to the second embodiment.

FIG. 12 is an enlarged plan view of the vicinity of a first high level portion of an array substrate according to a third embodiment.

FIG. 13 is a cross-sectional view taken along line xiii-xiii in FIG. 12 in a liquid crystal panel according to the third embodiment.

FIG. 14 is an enlarged plan view of the vicinity of a first high level portion of an array substrate according to a fourth embodiment.

FIG. 15 is an enlarged plan view of the vicinity of a first high level portion of an array substrate according to a fifth embodiment.

FIG. 16 is an enlarged plan view of the vicinity of a first high level portion of an array substrate according to a sixth embodiment.

FIG. 17 is a plan view of a liquid crystal panel, a flexible substrate, and a control substrate according to a seventh embodiment.

### DESCRIPTION OF EMBODIMENTS

### First Embodiment

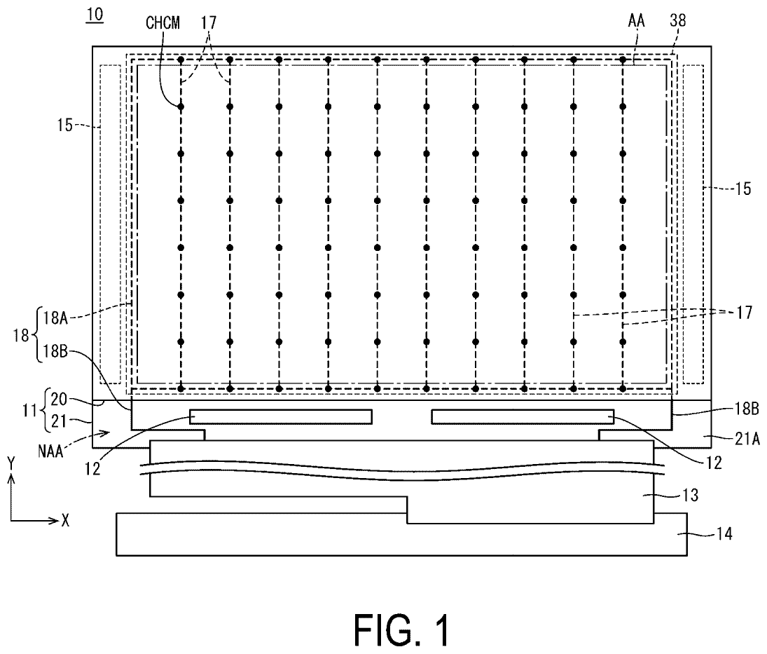

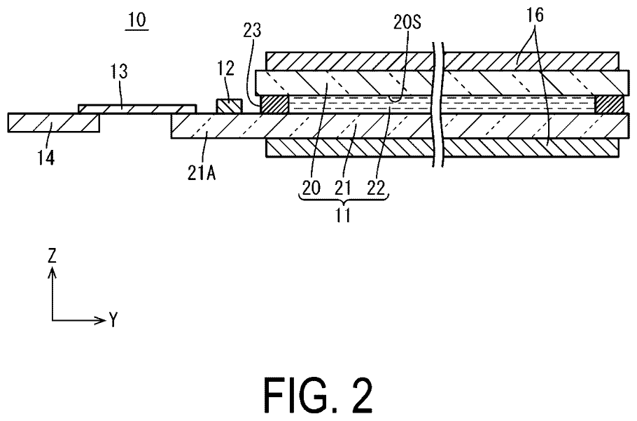

A first embodiment will be described with reference to FIGS. 1 to 8. In the present embodiment, a liquid crystal display device (a display device) 10 is described. Note that some drawings illustrate an X-axis, a Y-axis, and a Z-axis, and directions of these axes are drawn so as to be common in all the drawings. In addition, in FIGS. 2, 6, and 7, an upper side is defined as a front side, and a lower side is defined as a rear side.

The liquid crystal display device 10, as illustrated in FIG. 1, includes at least a liquid crystal panel (display panel) 11, which has a horizontally elongated rectangular shape and is capable of displaying an image, and a backlight device (illumination device) that irradiates the liquid crystal panel 11 with light for use in display. The backlight device includes a light source (for example, an LED or the like) disposed on a rear side (back face side) of the liquid crystal panel 11 and configured to emit light having a white color, an optical member configured to impart an optical effect on the light from the light source, thereby converting the light into planar light, and the like. A center-side portion of a main surface of the liquid crystal panel 11 is a display region AA in which an image is displayed. In contrast, an outer peripheral portion having a frame-like shape (frame-shaped) surrounding the display region AA of the main surface of the liquid crystal panel 11 is defined as a non-display region NAA in which no image is displayed.

The liquid crystal panel 11 will be described with reference to FIG. 2 in addition to FIG. 1. As illustrated in FIGS. 1 and 2, the liquid crystal panel 11 is formed by bonding a pair of substrates 20 and 21 together. Of a pair of substrates 20 and 21, the front side is a counter substrate (first substrate) 20, and the rear side is an array substrate (second substrate) 21. The counter substrate 20 and the array substrate 21 are each formed by layering various films on an inner face side of a glass substrate. A liquid crystal layer 22 is interposed between the pair of substrates 20, 21 and contains liquid crystal molecules, which are substances having optical characteristics that change in accordance with application of an electrical field. A sealing portion 23 that seals the liquid crystal layer 22 is provided to be interposed between outer peripheral end portions of the pair of substrates 20 and 21. The sealing portion 23 is formed in a rectangular frame-like shape to surround the liquid crystal layer 22. Note that polarizers 16 are bonded to the outer face sides of both the substrates 20 and 21, respectively.

As illustrated in FIG. 1 and FIG. 2, the counter substrate 20 has a short side dimension shorter than a short side dimension of the array substrate 21. The counter substrate 20 is bonded to the array substrate 21 with one end portion in a short side direction (Y-axis direction) aligned with the array substrate 21. Thus, the other end portion of the array substrate 21 in the short side direction is an exposed portion 21A that protrudes laterally relative to the counter substrate 20 and is exposed. The exposed portion 21A is entirely the non-display region NAA, and a driver (signal supply unit) 12 for supplying various signals and the flexible substrate 13 are mounted thereon.

As illustrated in FIGS. 1 and 2, the driver 12 is mounted on the exposed portion 21A of the array substrate 21 by Chip On Glass (COG). The driver 12 includes an LSI chip having a drive circuit therein. The driver 12 processes various signals transmitted by the flexible substrate 13 and supplies, for example, an image signal to a source wiring line 27 to be described later. The driver 12 is arranged adjacent to one side of the display region AA in the Y-axis direction in the exposed portion 21A and is disposed interposed between the flexible substrate 13 to be described below and the display region AA. The driver 12 is arranged in the exposed portion 21A at two positions spaced apart in an X-axis direction. The driver 12 has a horizontally elongated rectangular planar shape. The driver 12 has a long side dimension smaller than a long side dimension of the display region AA.

The flexible substrate 13 has a configuration in which a large number of wiring line patterns are formed on a base material made of a synthetic resin material (for example, a polyimide resin or the like) having insulating properties and flexibility. As illustrated in FIG. 1 and FIG. 2, one end side of the flexible substrate 13 is connected to the exposed portion 21A of the array substrate 21, and the other end side thereof is connected to a control substrate 14. The flexible substrate 13 is connected to an end portion of the exposed portion 21A on a side opposite to the display region AA side in the Y-axis direction with respect to the driver 12. That is, the flexible substrate 13 is attached to the exposed portion 21A at a position where the driver 12 is interposed between the flexible substrate 13 and the display region AA. The control substrate 14 is configured such that a plurality of circuit components are mounted on a rigid substrate made of a synthetic resin (for example, paper phenol, a glass epoxy resin, or the like). The plurality of circuit components include a power Integrated Circuit (IC) for outputting electric power, a timing controller that generates various signals to be supplied to the driver 12, a level shifter IC for controlling (step-down/step-up) voltage levels, and the like. The control substrate 14 includes a connector portion to which the flexible substrate 13 and the like are connected. The control substrate 14 is arranged so as to overlap the backlight device on a rear side by bending the flexible substrate 13 in a folded shape. The control substrate 14 supplies various signals to the driver 12.

As illustrated in FIG. 1, gate drive circuits 15 are provided in the non-display region NAA of the array substrate 21. A pair of gate drive circuits 15 is provided to sandwich the display region AA from both sides thereof in the X-axis direction. The gate drive circuits 15 are each provided in a vertically elongate belt-shaped range extending along the short side direction (Y-axis direction) of the array substrate 21. The gate drive circuit 15 is a circuit for supplying a scanning signal to a gate wiring line 26 to be described later and is provided monolithically on the array substrate 21. The scanning signal includes a potential higher than the threshold voltage of a TFT 24 to be described later.

As illustrated in FIG. 1, the array substrate 21 is provided with a common electrode 38 disposed over at least the entire area of the display region AA, a common wiring line 17 connected to the common electrode 38, and a common main wiring line 18 disposed in the non-display region NAA and connected to the common wiring line 17 and the flexible substrate 13. The common electrode 38 has a central portion disposed over the entire area of the display region AA, and an outer peripheral end portion having a frame-like shape and disposed in the non-display region NAA. The common main wiring line 18 is formed from a frame-shaped portion 18A having a frame-like shape that surrounds the display region AA, and a lead-out portion 18B led out from the frame-shaped portion 18A and routed to the flexible substrate 13. The frame-shaped portion 18A is disposed to overlap the outer peripheral end portion of the common electrode 38 and is connected to the common electrode 38. A common potential signal is supplied to the common main wiring line 18 from the control substrate 14 through the flexible substrate 13.

As illustrated in FIG. 1, the common wiring line 17 extends in the Y-axis direction so as to cross the display region AA. A plurality of the common wiring lines 17 are disposed side by side with intervals therebetween in the X-axis direction in the display region AA. The common wiring line 17 has both ends in the Y-axis direction connected to the frame-shaped portion 18A of the common main wiring line 18, and the central portion located closer to the center than both ends is connected to the common electrode 38 at multiple points. The common wiring line 17 is connected to the control substrate 14 through the common main wiring line 18 and the flexible substrate 13, and a common potential signal is supplied from the control substrate 14. In this way, a common potential signal is supplied to the common electrode 38 by the common main wiring line 18 in the non-display region NAA, and a common potential signal is also supplied by the plurality of common wiring lines 17 in the display region AA. This makes it possible to effectively reduce the resistance distribution of the common electrode 38.

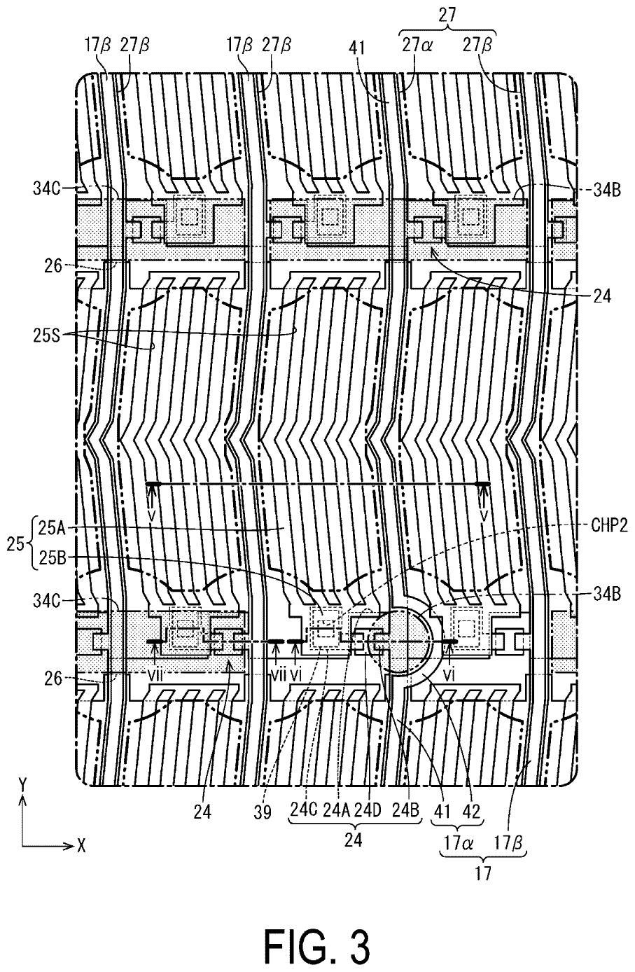

The pixel arrangement in the display region AA on the array substrate 21 will be described with reference to FIG. 3. As illustrated in FIG. 3, in the display region AA of the array substrate 21, a plurality of TFTs (switching elements, thin film transistors) 24 and a plurality of pixel electrodes 25 connected to the TFT 24 are provided side by side in a matrix shape. The gate wiring lines (scanning wiring lines) 26 and the source wiring lines (data wiring lines, signal wiring lines) 27, formed in a substantially lattice pattern, are disposed to surround the TFTs 24 and the pixel electrodes 25. The gate wiring line 26 extends substantially in the X-axis direction across the display region AA, and is connected to a gate electrode 24A of each of the TFTs 24. A plurality of gate wiring lines 26 are disposed side by side with intervals therebetween in the Y-axis direction. The source wiring line 27 extends substantially in the Y-axis direction (first direction) across the display region AA, and is connected to a source electrode 24B of each of the TFTs 24. A plurality of source wiring lines 27 are disposed with intervals therebetween in the X-axis direction (a second direction intersecting the first direction). The pixel electrode 25 is connected to a drain electrode 24C of the TFT 24.

As illustrated in FIG. 3, the TFT 24 has a semiconductor portion 24D in addition to the gate electrode 24A, the source electrode 24B, and the drain electrode 24C. The semiconductor portion 24D is made of a semiconductor material and is connected to the source electrode 24B and the drain electrode 24C. When the TFT 24 is driven on the basis of a scanning signal supplied to the gate wiring line 26, the TFT charges the pixel electrode 25 to a potential based on an image signal (data signal) supplied to the source wiring line 27. A plurality of TFTs 24 are arranged in a zig-zag shape so that those connected to the pixel electrode 25 on one side (left side in FIG. 3) in the X-axis direction with respect to the source wiring line 27 to be connected and those connected to the pixel electrode 25 on the other side (right side in FIG. 3) in the X-axis direction are alternately repeatedly arranged in the Y-axis direction.

As illustrated in FIG. 3, the pixel electrode 25 is disposed in a vertically elongated substantially rectangular region surrounded by the gate wiring line 26 and the source wiring line 27. The pixel electrode 25 has a main body portion 25A which is vertically elongated in a planar shape and a contact portion 25B connected to the drain electrode 24C of the TFT 24. The main body portion 25A is bent midway in the direction of its long side (longitudinal direction). More specifically, the main body portion 25A has both side edges on its longitudinal sides which are slightly inclined with respect to the Y-axis direction and are bent once at a substantially central position to form a shallow V-shape with an obtuse apex angle. The main body portion 25A has a bent portion at a substantially central position in the longitudinal direction. The pixel electrode 25 is interposed between a pair of gate wiring lines 26 from both sides in the Y-axis direction (longitudinal direction) and is interposed between a pair of source wiring lines 27 from both sides in the X-axis direction (short-hand direction). The source wiring line 27 interposed therebetween the pixel electrodes 25 adjacent to each other in the X-axis direction is parallel to the longitudinal side edges of the pixel electrodes 25, and is repeatedly bent in a zigzag pattern following the longitudinal side edge of each of the pixel electrodes 25. The main body portion 25A is provided with a plurality of slits 25S which are parallel to the source wiring line 27 and are arranged with intervals therebetween in the X-axis direction. The contact portion 25B extends out from the main body portion 25A in the Y-axis direction toward the gate wiring line 26 side (lower side in FIG. 3) connected to the TFT 24 including the drain electrode 24C to be connected. The contact portion 25B has a substantially rectangular shape in a plan view.

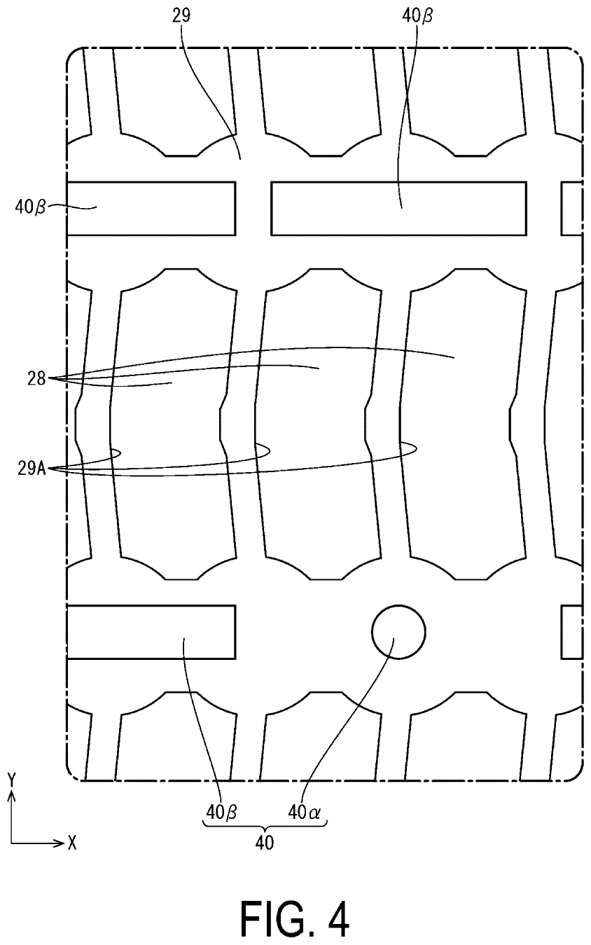

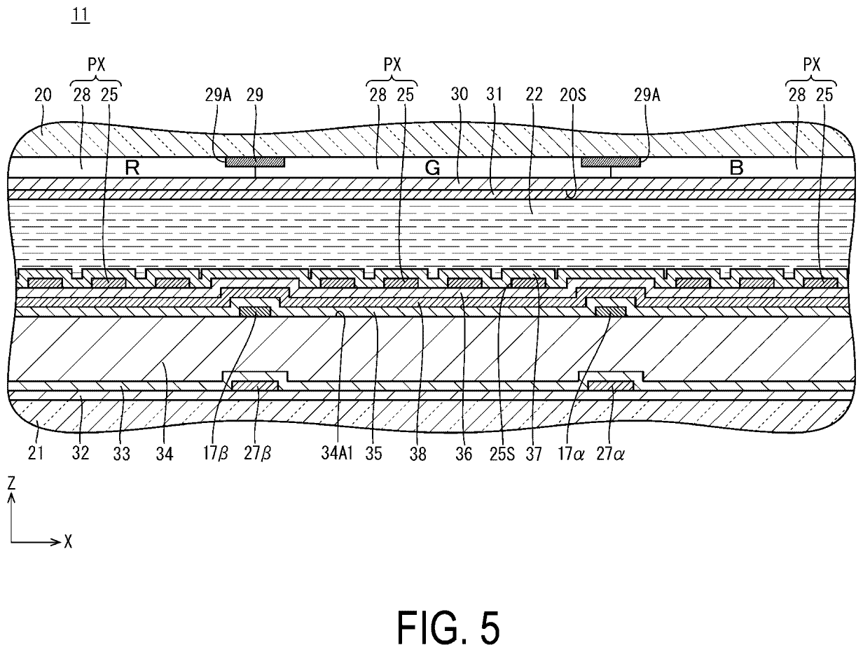

In the display region AA of the counter substrate 20 constituting the liquid crystal panel 11, as illustrated in FIG. 4, a large number of color filters 28 are provided at positions overlapping the pixel electrodes 25 provided on the array substrate 21. The color filters 28 are arranged in a pattern in which three colors of red (R), green (G), and blue (B) are alternately repeated along the X-axis direction. The color filters 28 of the three colors extend along the Y-axis direction, and are thereby arranged in a substantially stripe shape as a whole. More specifically, each of the color filters 28 of three colors extends generally in the Y-axis direction in parallel to the side edge of the source wiring line 27, and is repeatedly bent in a zigzag pattern along the side edge of the source wiring line 27. As illustrated in FIG. 5, the color filter 28 faces the pixel electrode 25 on the array substrate 21 side. The color filter 28 and the pixel electrode 25 overlapping each other configure a pixel PX which is a display unit.

As illustrated in FIG. 4, the display region AA of the counter substrate 20 is provided with a light blocking portion (black matrix) 29 that partitions (boundaries between) the color filters 28 (pixel electrodes 25) adjacent to each other in the X-axis direction and the Y-axis direction. The light blocking portion 29 is provided not only in the display region AA but also in the non-display region NAA. As illustrated in FIG. 5, the light blocking portion 29 overlaps the TFT 24, the gate wiring line 26, and the source wiring line 27 in the display region AA, is substantially lattice patterned in a planar shape to partition the pixel electrodes 25 adjacent to each other, and has a pixel opening 29A at a position overlapping most of the pixel electrode 25 in a plan view. This pixel opening 29A enables light transmitted through the pixel electrode 25 to be emitted to the outside of the liquid crystal panel 11. The light blocking portion 29 is substantially solid in the non-display region NAA. An overcoat film 30 is formed on the upper layer side of the color filter 28 and the light blocking portion 29. The overcoat film 30 is provided in a solid state over substantially the entire region of the counter substrate 20. The overcoat film 30 is made of, for example, an organic material such as an acrylic resin (for example, PMMA or the like). This overcoat film 30 flattens the inner face of the counter substrate 20 (the surface facing the array substrate 21). The upper face (surface) of the overcoat film 30 constitutes a first main surface 20S which is a reference face of the counter substrate 20. Meanwhile, a first alignment film 31 for aligning liquid crystal molecules included in the liquid crystal layer 22 is provided on the upper layer side of the overcoat film 30 (on the innermost face of the counter substrate 20). The first alignment film 31 is made of, for example, polyimide or the like.

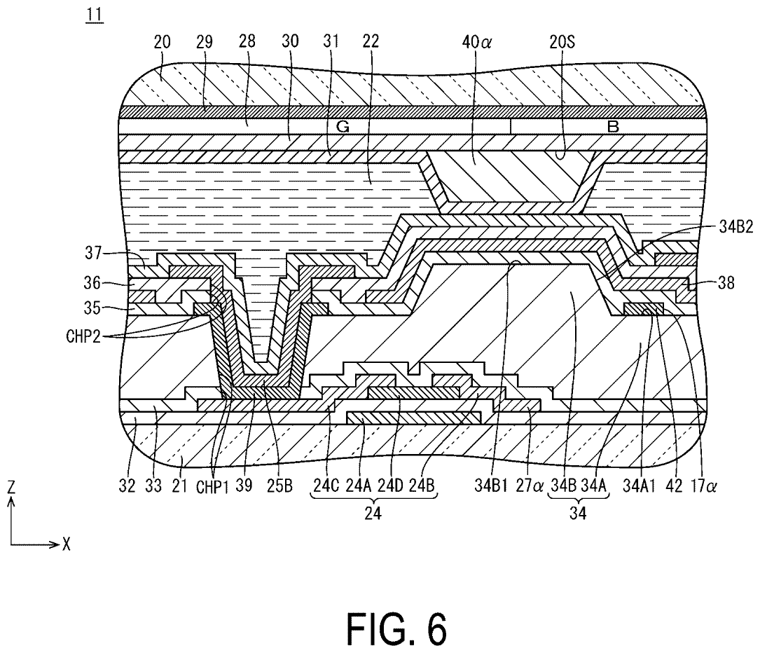

Here, various films layered on the inner face side of the array substrate 21 will be described with reference to FIGS. 5 and 6. As illustrated in FIGS. 5 and 6, the array substrate 21 has a first metal film, a gate insulating film 32, a semiconductor film, a second metal film (first conductive film), a first interlayer insulating film 33, a flattening film (first insulating film) 34, a third metal film (second conductive film), a second interlayer insulating film 35, a first transparent electrode film, a third interlayer insulating film 36, a second transparent electrode film, and a second alignment film 37 layered thereon in order from the lower layer side. The first metal film, the second metal film, and the third metal film are each a single-layer film composed of one type of metal material selected from copper, titanium, aluminum, molybdenum, tungsten, and the like, or a layered film or alloy composed of different types of metal materials, and thus have conductivity and light-blocking properties. The first metal film constitutes the gate wiring line 26, the gate electrode 24A of the TFT 24, and the like. The second metal film constitutes the source wiring line 27, the source electrode 24B and the drain electrode 24C of the TFT 24, and the like. The third metal film constitutes the common wiring line 17 and the like. The semiconductor film is made of a thin film using a material such as, for example, an oxide semiconductor or amorphous silicon, and constitutes the semiconductor portion 24D of the TFT 24, and the like. The first transparent electrode film and the second transparent electrode film are composed of a transparent electrode material (for example, Indium Tin Oxide (ITO) or Indium Zinc Oxide (IZO)). The first transparent electrode film constitutes the common electrode 38 and the like to be described later. The second transparent electrode film constitutes the pixel electrode 25 and the like. The second alignment film 37 is made of, for example, polyimide or the like similarly to the first alignment film 31, and is capable of aligning the liquid crystal molecules included in the liquid crystal layer 22.

The gate insulating film 32, the first interlayer insulating film 33, the second interlayer insulating film 35, and the third interlayer insulating film 36 are each made of an inorganic material such as silicon nitride (SiNₓ) or silicon oxide (SiO₂). The flattening film 34 is formed of an organic material such as PMMA (acrylic resin). The flattening film 34 has a thickness of, for example, about 1 μm to 3 μm, which is significantly greater than the thicknesses of the gate insulating film 32, the first interlayer insulating film 33, the second interlayer insulating film 35, and the third interlayer insulating film 36. This flattening film 34 flattens the inner face of the array substrate 21 (the surface facing the counter substrate 20). The gate insulating film 32 maintains an insulated state between the first metal film on the lower layer side and the semiconductor film and the second metal film on the upper layer side. For example, the intersection between the gate wiring line 26 formed from the first metal film and the source wiring line 27 formed from the second metal film is maintained in an insulated state by the gate insulating film 32. The first interlayer insulating film 33 and the flattening film 34 maintain an insulated state between the semiconductor film and the second metal film on the lower layer side and the third metal film on the upper layer side. The second interlayer insulating film 35 maintains an insulated state between the third metal film on the lower layer side and the first transparent electrode film on the upper layer side. The third interlayer insulating film 36 maintains an insulated state between the first transparent electrode film on the lower layer side and the second transparent electrode film on the upper layer side.

As illustrated in FIG. 5, the common electrode 38 extends over the entire area of the display region AA and is disposed to overlap all of the pixel electrodes 25 disposed in the display region AA on the lower layer side. The common electrode 38 formed from a portion of the first transparent electrode film is maintained in an insulated state with respect to each of the pixel electrodes 25 formed from a portion of the second transparent electrode film by the third interlayer insulating film 36 interposed therebetween. A common potential (reference potential) is supplied to the common electrode 38 by the common wiring line 17 and the common main wiring line 18. Therefore, a potential difference based on the potential charged to the pixel electrode 25 can occur between the common electrode 38 and the pixel electrode 25. The electrical field generated on the basis of the potential difference between the common electrode 38 and the pixel electrode 25 includes a fringe electrical field (oblique electrical field) including a component along the main surface of the array substrate 21 as well as a component in a normal direction normal to the main surface of the array substrate 21. Therefore, the display mode of the liquid crystal panel 11 according to the present embodiment is a so-called fringe field switching (FFS) mode in which the alignment state of the liquid crystal included in the liquid crystal layer 22 is controlled using a fringe electrical field.

As illustrated in FIGS. 3 and 5, the common wiring line 17 is disposed to overlap the source wiring line 27 in a plan view. The common wiring line 17 formed from a portion of the third metal film is maintained in an insulated state with respect to the source wiring line 27 formed from a portion of the second metal film by the first interlayer insulating film 33 and the flattening film 34 interposed therebetween. The common wiring line 17 extends substantially in the Y-axis direction in parallel to the source wiring line 27, and more specifically, is parallel to the longitudinal side edge of the pixel electrode 25 and is repeatedly bent in a zigzag pattern along the longitudinal side edge of each of the pixel electrodes 25. In this way, since the common wiring line 17 is disposed to overlap the source wiring line 27, the aperture ratio of the pixel PX is less likely to decrease due to the common wiring line 17. In addition, the common wiring line 17 formed from a portion of the third metal film is connected to the common electrode 38 formed from a portion of the first transparent electrode film through a common contact hole CHCM formed as an opening in the second interlayer insulating film 35 interposed therebetween (see FIG. 1). The common contact hole CHCM is disposed at positions overlapping the common wiring line 17, that is, a plurality of positions spaced apart from each other in the extending direction of the common wiring line 17 (Y-axis direction).

Next, the cross-sectional configuration of the TFT 24 will be described mainly with reference to FIG. 6. As illustrated in FIG. 6, the TFT 24 has the gate electrode 24A formed from the first metal film. The gate electrode 24A is formed by locally widening a portion of the gate wiring line 26 near the intersection with the source wiring line 27 (see FIG. 3). The gate electrode 24A drives the TFT 24 on the basis of a scanning signal supplied to the gate wiring line 26. The TFT 24 has the source electrode 24B formed from the second metal film. The source electrode 24B is formed by locally widening a portion of the source wiring line 27 near the intersection with the gate wiring line 26 (see FIG. 3). The source electrode 24B is disposed at one end of the TFT 24 in the X-axis direction. The source electrode 24B overlaps a portion of the gate electrode 24A and is connected to the semiconductor portion 24D.

As illustrated in FIG. 6, the TFT 24 has the drain electrode 24C formed from the second metal film. The drain electrode 24C is disposed at a position spaced apart from the source electrode 24B in the X-axis direction, that is, at the other end of the TFT 24 in the X-axis direction. The end portion of the drain electrode 24C on the source electrode 24B side is disposed to overlap a portion of the gate electrode 24A and is connected to the semiconductor portion 24D. The end portion of the drain electrode 24C on a side opposite to the source electrode 24B side is disposed to overlap the contact portion 25B of the pixel electrode 25. An intermediate electrode 39 formed from a portion of the third metal film is provided at a position overlapping both the drain electrode 24C and the contact portion 25B. The intermediate electrode 39 is located between the drain electrode 24C and the contact portion 25B in the Z-axis direction. A first pixel contact hole CHP1 is provided as an opening in the first interlayer insulating film 33 and the first flattening film 34 interposed between the drain electrode 24C and the intermediate electrode 39 overlapping each other at a position overlapping the drain electrode 24C and the intermediate electrode 39. The intermediate electrode 39 is connected to the drain electrode 24C through the first pixel contact hole CHP1. A second pixel contact hole CHP2 is provided as an opening in the second interlayer insulating film 35 and the third interlayer insulating film 36 interposed between the intermediate electrode 39 and the contact portion 25B overlapping each other at a position overlapping the intermediate electrode 39 and the contact portion 25B. The contact portion 25B of the pixel electrode 25 is connected to the intermediate electrode 39 through the second pixel contact hole CHP2. In this way, the pixel electrode 25 is connected to the drain electrode 24C through the intermediate electrode 39.

As illustrated in FIG. 6, the TFT 24 has an island-shaped semiconductor portion 24D including a channel portion. The semiconductor portion 24D has a horizontally elongated shape extending in the X-axis direction. The semiconductor portion 24D is disposed to overlap the gate electrode 24A. The semiconductor portion 24D formed from a portion of the semiconductor film is maintained in an insulated state with respect to the gate electrode 24A formed from a portion of the first metal film by the gate insulating film 32 interposed therebetween. One end-side portion of the semiconductor portion 24D is connected to the source electrode 24B. The other end-side portion of the semiconductor portion 24D is connected to the drain electrode 24C. A portion of the semiconductor portion 24D that overlaps the gate electrode 24A but does not overlap the source electrode 24B and the drain electrode 24C is a channel portion functioning as a channel (current path). When the TFT 24 turned on based on a scanning signal supplied to the gate electrode 24A, an image signal (data signal) supplied to the source wiring line 27 is supplied from the source electrode 24B through the semiconductor portion 24D to the drain electrode 24C. As a result, the pixel electrode 25 is charged to a potential based on the image signal.

Next, the detailed configuration of the flattening film 34 will be described with reference to FIGS. 3, 6, and 7. As illustrated in FIGS. 3, 6, and 7, the flattening film 34 interposed between the source wiring line 27 formed from a portion of the second metal film and the common wiring line 17 formed from a portion of the third metal film has a low level portion 34A, a first high level portion (main bump) 34B higher than the low level portion 34A, and a second high level portion (sub-bump) 34C higher than the low level portion 34A. That is, the flattening film 34 is configured to have a partially different film thickness (height). In this way, the flattening film 34 having a cross-sectional shape with a partially different film thickness is formed by using a photosensitive material as an organic material and by using a halftone exposure technique. Meanwhile, in FIG. 3, the formation ranges of the first high level portion 34B and the second high level portion 34C are illustrated by hatching.

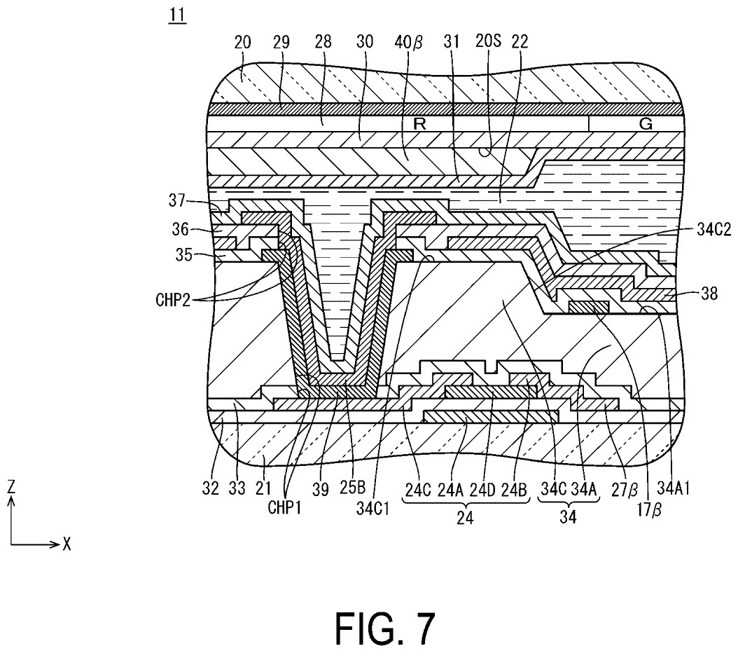

As illustrated in FIGS. 6 and 7, the low level portion 34A has a first upper face 34A1 as its upper face. The low level portion 34A is a portion of the flattening film 34 which is smallest in film thickness. The low level portion 34A is disposed in a region of the flattening film 34 in which the first high level portion 34B and the second high level portion 34C are not disposed, and occupies most of the flattening film 34. Specifically, the low level portion 34A is disposed in a range that overlaps the main body portion 25A of the pixel electrode 25 and most of the source wiring line 27 excluding the portion that intersects the gate wiring line 26 (a range that does not overlap a portion of the light blocking portion 29 on the counter substrate 20 that extends in the X-axis direction). The first upper face 34A1 of the low level portion 34A constitutes a second main surface which is a reference face of the array substrate 21.

As illustrated in FIGS. 6 and 7, the first high level portion 34B protrudes from the first upper face 34A1 toward the counter substrate 20 (the upper side in FIGS. 6 and 7). The first high level portion 34B has, as its upper face, a second upper face (protruding tip end face) 34B1 higher than the first upper face 34A1. The first high level portion 34B has a tapered shape in which the protruding tip portion is thinner than the protruding base portion, and is configured such that the second upper face 34B1 is a plane (in the X-axis direction and the Y-axis direction) with the Z-axis direction as its normal, while the side surface (peripheral surface) 34B2 is an inclined surface which is inclined with respect to the Z-axis direction. The first high level portion 34B is a portion of the flattening film 34 which is greatest in film thickness. As illustrated in FIG. 3, the first high level portion 34B is disposed near the intersection between a specific gate wiring line 26 and a specific source wiring line 27. That is, the first high level portions 34B are not disposed at all of the intersections between a plurality of gate wiring lines 26 and a plurality of source wiring lines 27, but are discretely disposed in a predetermined distribution within the plane of the display region AA. More specifically, the first high level portion 34B is disposed to overlap a portion of the source wiring line 27 adjacent to the intersection with the gate wiring line 26 (a portion continuous with the source electrode 24B). In addition, the first high level portion 34B is also disposed to overlap the source electrode 24B of the TFT 24. The first high level portion 34B has a substantially circular columnar shape in a plan view. The second upper face 34B1 of the first high level portion 34B has a diameter greater than the line width of the source wiring line 27 and is positioned to protrude from the source wiring line 27 on both the left and right sides in the X-axis direction.

As illustrated in FIGS. 6 and 7, the second high level portion 34C protrudes from the first upper face 34A1 toward the counter substrate 20 similarly to the first high level portion 34B. The projection dimension (height dimension, that is, the distance in the Z-axis direction between the first upper face 34A1 and a third upper face 34C1) of the second high level portion 34C from the first upper face 34A1 is substantially equal to the projection dimension (the distance in the Z-axis direction between the first upper face 34A1 and the second upper face 34B1) of the first high level portion 34B. The second high level portion 34C has, as its upper face, the third upper face (protruding tip end face) 34C1 higher than the first upper face 34A1. The third upper face 34C1 is set to have substantially the same height as the second upper face 34B1. The second high level portion 34C has a tapered shape in which the protruding tip portion is thinner than the protruding base portion, and is configured such that the third upper face 34C1 is a plane with the Z-axis direction as its normal, while a side surface 34C2 is an inclined surface which is inclined with respect to the Z-axis direction. The second high level portion 34C is a portion of the flattening film 34 which is greater than in film thickness than the low level portion 34A. As illustrated in FIG. 3, the second high level portion 34C is disposed to overlap the TFT 24, the contact portion 25B of the pixel electrode 25, the gate wiring line 26, and a portion of the source wiring line 27 (the intersection with the gate wiring line 26). The second high level portion 34C has a horizontally elongated columnar shape extending in the X-axis direction in a plan view. The second high level portion 34C is disposed across two pixels PX aligned in the X-axis direction, and overlaps two TFTs 24 and two contact portions 25B. The second high level portions 34C are disposed at intersections between a plurality of gate wiring lines 26 and a plurality of source wiring lines 27 where the first high level portions 34B are not disposed. The number of second high level portions 34C installed is greater than the number of first high level portions 34B installed.

As illustrated in FIGS. 4, 6, and 7, the display region AA of the counter substrate 20 is provided with spacers 40 protruding from the first main surface 20S toward the array substrate 21. The spacers 40 are made of an organic material such as, for example, PMMA (acrylic resin) similarly to the flattening film 34. The spacers 40 are disposed at a position overlapping each of the high level portions 34B and 34C provided on the array substrate 21 in a plan view. The number of spacers 40 installed is equal to the sum of the number of high level portions 34B and 34C installed. The spacer 40 indirectly contacts each of the overlapping high level portions 34B and 34C through each of the alignment films 31 and 37, and the like, thereby holding the distance between a pair of substrates 20 and 21, that is, the cell gap (thickness of the liquid crystal layer 22) at or above a certain level. Specifically, a portion of the first alignment film 31, constituting the surface of the counter substrate 20 facing the array substrate 21, which overlaps the spacer 40 is in direct contact with a portion of the second alignment film 37, constituting the surface of the array substrate 21 facing the counter substrate 20, which overlaps each of the high level portions 34B and 34C.

As illustrated in FIGS. 4, 6, and 7, the spacer 40 includes a first spacer (main spacer) 40α and a second spacer (sub-spacer) 40β of which the projection dimension from the counter substrate 20 is smaller than that of the first spacer 40α. Meanwhile, hereinafter, when distinguishing between the spacers 40, the suffix “α” is added to the reference numeral of the first spacer and the suffix “β” is added to the reference numeral of the second spacer, whereas when referring to the spacers collectively without distinction, no suffix is added to the reference numeral. In this way, the two types of spacers 40α and 40β having different heights are formed by using a photosensitive material such as an organic material and by using a halftone exposure technique.

As illustrated in FIGS. 6 and 7, the first spacer 40α has a larger projection dimension from the first main surface 20S of the counter substrate 20 than the second spacer 40B. The first spacer 40α has a tapered shape in which the protruding tip portion is narrower than the protruding base portion. The first spacer 40α is disposed at a position overlapping the first high level portion 34B of the array substrate 21 side in a plan view. That is, the first spacers 40α are not disposed at all of the intersections between a plurality of gate wiring lines 26 and a plurality of source wiring lines 27, but are discretely disposed in a predetermined distribution within the plane of the display region AA. The number of first spacers 40α installed is equal to the number of first high level portions 34B installed. In a state where no external force or the like is acting on the counter substrate 20 and the array substrate 21 and no deflection occurs in both the counter substrate 20 and the array substrate 21 (a state where the thickness of the liquid crystal layer 22 is set to a design value), a portion of the surface of the counter substrate 20 facing the array substrate 21 that overlaps the first spacer 40α and a portion of the surface of the array substrate 21 facing the counter substrate 20 that overlaps the first high level portion 34B are in contact with each other. That is, the first spacer 40α is maintained in a state of constant indirect contact with the inner face (the second alignment film 37) of the array substrate 21, thereby maintaining a good gap between the pair of substrates 20 and 21. As illustrated in FIG. 4, the first spacer 40α has a substantially circular columnar shape in a plan view.

As illustrated in FIGS. 6 and 7, the second spacer 40β has a smaller projection dimension from the first main surface 20S of the counter substrate 20 than the first spacer 40α. The second spacer 40β has a tapered shape in which the protruding tip portion is narrower than the protruding base portion. The second spacer 40β is disposed at a position overlapping the second high level portion 34C of the array substrate 21 side in a plan view. The number of second spacers 40β installed is equal to the number of second high level portions 34C installed. Therefore, the number of second spacers 40β installed is greater than the number of first spacers 40α installed. In a state where no deflection occurs in both the counter substrate 20 and the array substrate 21 (a state where the thickness of the liquid crystal layer 22 is set to the design value), a gap (clearance) is provided between a portion of the surface of the counter substrate 20 facing the array substrate 21 that overlaps the second spacer 40B and a portion of the surface of the array substrate 21 facing the counter substrate 20 that overlaps the second high level portion 34C, and the two portions do not come into contact with each other. On the other hand, in a state where deflection occurs due to an external force acting on either or both of the counter substrate 20 and the array substrate 21 (a state where the thickness of the liquid crystal layer 22 is set to the design value), a portion of the surface of the counter substrate 20 facing the array substrate 21 that overlaps the second spacer 40β and a portion of the surface of the array substrate 21 facing the counter substrate 20 that overlaps the second high level portion 34C come into contact with each other. This prevents either or both of the substrates 20 and 21 from bending further. In this way, since the second spacer 40β is always prevented from contacting the inner face of the array substrate 21, a portion of the second alignment film 37 present on the inner face of the array substrate 21 that overlaps the second spacer 40β is less likely to be scraped off by the second spacer 40β. This enables the light-blocking range near the second spacer 40β to be narrower than the light-blocking range near the first spacer 40α, which is suitable for maintaining a high aperture ratio of the pixel PX. In particular, the number of second spacers 40β installed is greater than the number of first spacers 40α installed, and thus the aperture ratio of the pixel PX is maintained high. As described above, the thickness of the liquid crystal layer 22, that is, the cell gap, can be maintained by the first spacer 40α and the second spacer 40β. As illustrated in FIG. 4, the second spacer 40β has a horizontally elongated columnar shape extending in the X-axis direction in a plan view.

Hereinafter, when distinguishing between a plurality of source wiring lines 27, the source wiring line 27 that overlaps the first high level portion 34B and the first spacer 40α is referred to as the “first source wiring line (first wiring line)” with the suffix α added to the reference numeral, and the source wiring lines 27 other than the first source wiring line 27α are referred to as the “second source wiring lines” with the suffix β added to the reference numeral, whereas when referring to the source wiring lines collectively without distinction, no suffix is added to the reference numeral. In addition, when distinguishing between a plurality of common wiring lines 17, the common wiring line 17 that overlaps the first source wiring line 27α is referred to as the “first common wiring line (second wiring line)” with the suffix α added to the reference numeral, and the common wiring line 17 other than the first common wiring line 17α is referred to as the “second common wiring line” with the suffix β added to the reference numeral, whereas when referring to the common wiring lines collectively without distinction, no suffix is added to the reference numeral.

As illustrated in FIG. 3, the first source wiring line 27α has the same configuration as the second source wiring line 27β. In contrast, the first common wiring line 17α has a different configuration from the second common wiring line 17β. That is, the second common wiring line 17β extends along the second source wiring line 27β in an overlapping relationship therewith, and does not have a portion protruding from the second source wiring line 27β at least in the display region AA. In contrast, the first common wiring line 17α is different in configuration from the second common wiring line 17β in that, although most of the first common wiring line extends along the first source wiring line 27α in an overlapping relationship therewith, it has a portion protruding from the first source wiring line 27α in the display region AA.

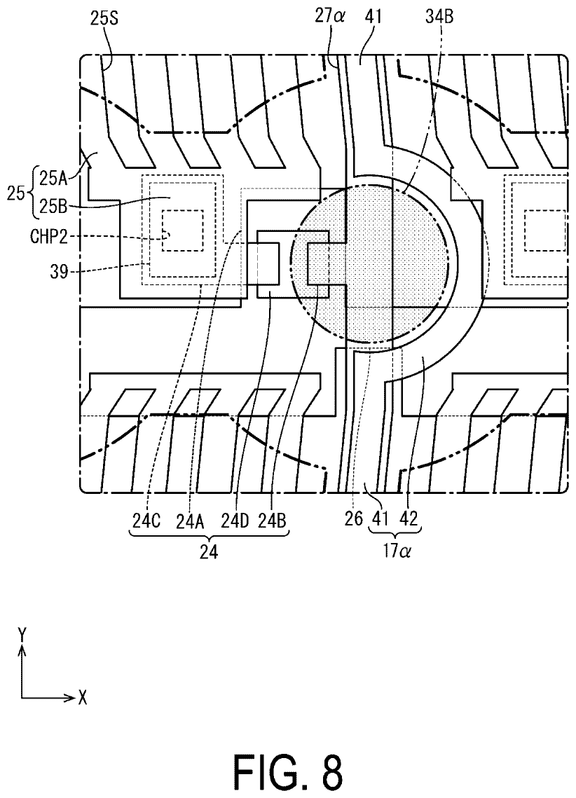

More specifically, as illustrated in FIG. 3, the first common wiring line 17α has an overlapping portion 41 that overlaps most of the first source wiring line 27α and a non-overlapping portion 42 that does not overlap the second upper face 34B1 of the first high level portion 34B. The overlapping portion 41 is a portion of the first common wiring line 17α that extends along the first source wiring line 27α, and is disposed to overlap a portion of the first source wiring line 27α that does not overlap the second upper face 34B1 of the first high level portion 34B. As illustrated in FIG. 8, two overlapping portions 41 are disposed at positions where the first high level portion 34B (non-overlapping portion 42) is interposed in the Y-axis direction. Meanwhile, in FIG. 8, the formation range of the first high level portion 34B illustrated by hatching. The two overlapping portions 41 include an overlapping portion 41 disposed on the driver 12 side (lower side in FIG. 8) relative to the first high level portion 34B, and an overlapping portion 41 disposed on a side opposite to the driver 12 (upper side in FIG. 8) relative to the first high level portion 34B. The non-overlapping portion 42 is a portion of the first common wiring line 17α that protrudes laterally from the first source wiring line 27α, and is formed as a planar shape curved to bypass the first high level portion 34B. The non-overlapping portion 42 extends along the outward shape of the first high level portion 34B and has a substantially semicircular arc shape in a plan view. Both ends of the non-overlapping portion 42 are connected to the ends of the two overlapping portions 41, respectively. In this way, the first common wiring line 17α is routed around the first high level portion 34B so as not to overlap the second upper face 34B1 of the first high level portion 34B.

As illustrated in FIGS. 6 and 8, the first common wiring line 17α according to the present embodiment has a non-overlapping portion 42, continuous with the overlapping portion 41, which is disposed to bypass the first high level portion 34B and does not overlap the second upper face 34B1. That is, the first common wiring line 17α formed from a portion of the third metal film located on the upper layer side of the flattening film 34 does not have a portion that overlaps the second upper face 34B1 of the first high level portion 34B, and thus local unevenness caused by the first common wiring line 17α is avoided from occurring on the second upper face 34B1 of the first high level portion 34B. This ensures a sufficient contact area between a portion of the first alignment film 31, constituting the surface of the counter substrate 20 facing the array substrate 21, that overlaps the first spacer 40α and a portion of the second alignment film 37, constituting the surface of the array substrate 21 facing the counter substrate 20, that overlaps the first high level portion 34B, which makes it less likely that dust will be generated on each of the alignment films 31 and 37 due to their wear and increases the certainty that a function of holding the distance between the counter substrate 20 and the array substrate 21 (cell gap holding function) will be appropriately performed. When the generation of dust on each of the alignment films 31 and 37 is suppressed, the light-blocking range of the light blocking portion 29 near the first spacer 40α and the first high level portion 34B can be narrowed, which makes it possible to increase the aperture ratio of the pixel PX. In this way, the overlapping portion 41 of the first common wiring line 17α can be disposed to overlap the first source wiring line 27α which is in an overlapping relationship with the first spacer 40α and the first high level portion 34B, and thus the number of first common wiring lines 17α installed can be increased compared to the known case in which the spacer and the high level portion are disposed not to overlap the wiring line. In the present embodiment, the common wiring line 17 is disposed to overlap all the source wiring lines 27. That is, the number of common wiring lines 17 installed is equal to the number of source wiring lines 27 installed, and the number of common wiring lines 17 installed is maximized without lowering the aperture ratio of the pixel PX. This is suitable for reducing the resistance distribution of the common electrode 38.

Moreover, as illustrated in FIG. 8, the non-overlapping portion 42 extends along the outward shape of the first high level portion 34B, and thus the length of the non-overlapping portion 42 can be minimized. This makes it possible to suppress an increase in wiring line resistance caused by the first common wiring line 17α bypassing the first high level portion 34B. Meanwhile, the non-overlapping portion 42 is disposed at a position spaced sufficiently apart in the X-axis direction from the intermediate electrode 39 that overlaps the drain electrode 24C of the TFT 24, thereby preventing a short circuit with the intermediate electrode 39.

Furthermore, as illustrated in FIG. 6, the non-overlapping portion 42 is disposed on the first upper face 34A1 of the low level portion 34A, and is also disposed not to overlap the side surface 34B2 in addition to the second upper face 34B1 of the first high level portion 34B. That is, the non-overlapping portion 42 overlaps the low level portion 34A and is disposed not to overlap the entire area of the first high level portion 34B, so that the occurrence of local unevenness caused by the first common wiring line 17α on the first high level portion 34B can be more reliably avoided. This ensures a sufficient contact area between a portion of the surface of the counter substrate 20 facing the array substrate 21 that overlaps the first spacer 40α and a portion of the surface of the array substrate 21 facing the counter substrate 20 that overlaps the first high level portion 34B.

In addition, in the present embodiment, as illustrated in FIGS. 3 and 7, the plurality of second high level portions 34C and the plurality of second spacers 40β include those that overlap a portion of the first source wiring line 27α. The overlapping portion 41 of the first common wiring line 17α is disposed to overlap the second high level portion 34C and the second spacer 40β which are in an overlapping relationship with the first source wiring line 27α. That is, the first common wiring line 17α is routed to bypass the first high level portion 34B but not to bypass the second high level portion 34C. Therefore, the overlapping portion 41 of the first common wiring line 17α is disposed on the third upper face 34C1 of the second high level portion 34C. For this reason, local unevenness caused by the first common wiring line 17α occurs in a portion of the surface of the array substrate 21 facing the counter substrate 20 that overlaps the second high level portion 34C. With such a configuration, in a state where no deflection occurs in both the counter substrate 20 and the array substrate 21, a gap is also provided between the portion of the surface of the counter substrate 20 facing the array substrate 21 that overlaps the second spacer 40β and the portion of the surface of the array substrate 21 facing the counter substrate 20 that overlaps the second high level portion 34C. Therefore, even when local unevenness caused by the first common wiring line 17α occurs in the portion of the surface of the array substrate 21 facing the counter substrate 20 that overlaps the second high level portion 34C, dust is less likely to be generated on each of the alignment films 31 and 37. In contrast, in a state where no deflection occurs in both the counter substrate 20 and the array substrate 21, the portion of the surface of the counter substrate 20 facing the array substrate 21 that overlaps the first spacer 40α is in contact with a portion of the surface of the array substrate 21 facing the counter substrate 20 that overlaps the first high level portion 34B of the flattening film 34. In this respect, as described above, the occurrence of local unevenness caused by the first common wiring line 17α on the second upper face 34B1 of the first high level portion 34B is avoid, so that a sufficient contact area is secured between the portion of the surface of the counter substrate 20 facing the array substrate 21 that overlaps the first spacer 40α and the portion of the surface of the array substrate 21 facing the counter substrate 20 that overlaps the first high level portion 34B, which makes it less likely that dust will be generated due to their wear and increases the certainty that a function of holding the distance between the counter substrate 20 and the array substrate 21 will be appropriately performed.

As described above, the liquid crystal panel (display device) 11 of the present embodiment includes the counter substrate (first substrate) 20, the array substrate (second substrate) 21 facing the counter substrate 20 with an interval therebetween, the first spacer 40α provided on the counter substrate 20 and protruding from the counter substrate 20 toward the array substrate 21, the first source wiring line (first wiring line) 27α provided on the array substrate 21 and formed from a portion of the second metal film (first conductive film), the flattening film (first insulating film) 34 provided on the array substrate 21 and disposed on the upper layer side of the second metal film, and the first common wiring line (second wiring line) 17α provided on the array substrate 21 and formed from a portion of the third metal film (second conductive film) disposed on the upper layer side of the flattening film 34, in which the flattening film 34 includes the low level portion 34A including the first upper face 34A1 as its upper face, and the first high level portion 34B protruding from the first upper face 34A1 toward the counter substrate 20 and including the second upper face 34B1 higher than the first upper face 34A1 as its upper face, the first high level portion 34B overlaps the first spacer 40α and is disposed to overlap a portion of the first source wiring line 27α, and the first common wiring line 17α includes the overlapping portion 41 overlapping a portion of the first source wiring line 27α that does not overlap the second upper face 34B1, and the non-overlapping portion 42, continuous with the overlapping portion 41, which is disposed to bypass the first high level portion 34B and does not overlap the second upper face 34B1.

The portion of the surface of the counter substrate 20 facing the array substrate 21 that overlaps the first spacer 40α is configured to be able to contact the portion of the surface of the array substrate 21 facing the counter substrate 20 that overlaps the first high level portion 34B of the flattening film 34. This allows the distance (cell gap) between the counter substrate 20 and the array substrate 21 facing each other to be reliably held. The first common wiring line 17α formed from a portion of the third metal film has the overlapping portion 41 that overlaps a portion of the first source wiring line 27α formed from a portion of the second metal film that does not overlap the second upper face 34B1, and thus the aperture ratio is less likely to decrease due to the first common wiring line 17α. The overlapping portion 41 and the first source wiring line 27α are maintained in an insulated state by the flattening film 34. The first common wiring line 17α has the non-overlapping portion 42, continuous with the overlapping portion 41, which is disposed to bypass the first high level portion 34B and does not overlap the second upper face 34B1, and thus it is possible to avoid local unevenness caused by the first common wiring line 17α from occurring on the second upper face 34B1 of the first high level portion 34B. This ensures a sufficient contact area between a portion of the surface of the counter substrate 20 facing the array substrate 21 that overlaps the first spacer 40α and a portion of the surface of the array substrate 21 facing the counter substrate 20 that overlaps the first high level portion 34B, which makes it less likely that dust will be generated due to their wear and increases the certainty that a function of holding the distance between the counter substrate 20 and the array substrate 21 will be appropriately performed. In this way, the overlapping portion 41 of the first common wiring line 17α can be disposed to overlap the first source wiring line 27α which is in an overlapping relationship with the first spacer 40α and the first high level portion 34B, and thus the number of first common wiring lines 17α installed can be increased compared to the known case in which the spacer and the high level portion are disposed not to overlap the wiring line.

In addition, the non-overlapping portion 42 extends along the outward shape of the first high level portion 34B. The length of the non-overlapping portion 42 can be minimized. This makes it possible to suppress an increase in wiring line resistance caused by the first common wiring line 17α bypassing the first high level portion 34B.

In addition, the non-overlapping portion 42 is disposed on the first upper face 34A1 of the low level portion 34A. Since the non-overlapping portion 42 overlaps the low level portion 34A and is disposed not to overlap the first high level portion 34B, it is possible to avoid local unevenness caused by the first common wiring line 17α from occurring on the first high level portion 34B. This ensures a sufficient contact area between the portion of the surface of the counter substrate 20 facing the array substrate 21 that overlaps the first spacer 40α and the portion of the surface of the array substrate 21 facing the counter substrate 20 that overlaps the first high level portion 34B.

In addition, the second spacer 40β provided on the counter substrate 20 and protrudes from the counter substrate 20 toward the array substrate 21 is included, in which the second spacer 40β has a smaller projection dimension from the counter substrate 20 than the first spacer 40α, the flattening film 34 includes the second high level portion 34C that protrudes from the first upper face 34A1 toward the counter substrate 20 and has, as its upper face, the third upper face 34C1 which is higher than the first upper face 34A1 and at the same height as the second upper face 34B1 or lower than the second upper face 34B1, the second high level portion 34C overlaps the second spacer 40β and overlaps a portion of the first source wiring line 27α, and the portion of the surface of the counter substrate 20 facing the array substrate 21 that overlaps the first spacer 40α contacts the portion of the surface of the array substrate 21 facing the counter substrate 20 that overlaps the first high level portion 34B. The second spacer 40β has a smaller projection dimension from the counter substrate 20 than the first spacer 40α, and the second high level portion 34C that overlaps the second spacer 40β has the third upper face 34C1 which is higher than the first upper face 34A1 and at the same height as the second upper face 34B1 or lower than the second upper face 34B1. Therefore, a gap is provided between the portion of the surface of the counter substrate 20 facing the array substrate 21 that overlaps the second spacer 40β and the portion of the surface of the array substrate 21 facing the counter substrate 20 that overlaps the second high level portion 34C of the flattening film 34. Therefore, in a case where deflection occurs in the counter substrate 20 or the array substrate 21 due to, for example, an external force acting on the counter substrate 20 or the array substrate 21, the portion of the surface of the counter substrate 20 facing the array substrate 21 that overlaps the second spacer 40β is configured to be able to contact the portion of the surface of the array substrate 21 facing the counter substrate 20 that overlaps the second high level portion 34C of the flattening film 34. In contrast, even in a state where no external force or the like is acting on the counter substrate 20 or the array substrate 21, the portion of the surface of the counter substrate 20 facing the array substrate 21 that overlaps the first spacer 40α is in contact with the portion of the surface of the array substrate 21 facing the counter substrate 20 that overlaps the first high level portion 34B of the flattening film 34, which makes it more likely that problems such as dust generation will occur. In this respect, as described above, the occurrence of local unevenness caused by the first common wiring line 17α on the second upper face 34B1 of the first high level portion 34B is avoid, so that a sufficient contact area is secured between the portion of the surface of the counter substrate 20 facing the array substrate 21 that overlaps the first spacer 40α and the portion of the surface of the array substrate 21 facing the counter substrate 20 that overlaps the first high level portion 34B, which makes it less likely that dust will be generated due to their wear and increases the certainty that a function of holding the distance between the counter substrate 20 and the array substrate 21 will be appropriately performed.

### Second Embodiment

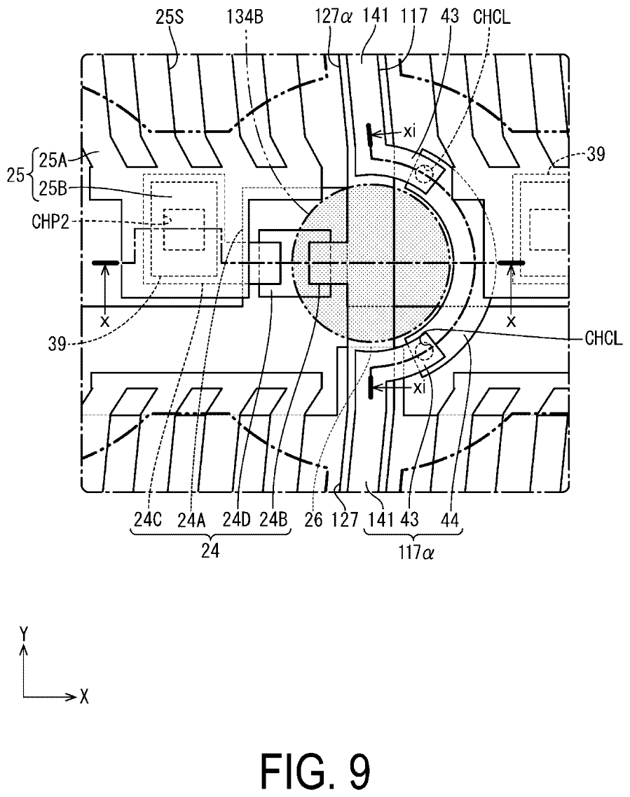

A second embodiment will be described with reference to FIGS. 9 to 11. This second embodiment illustrates a case where the configuration of a first common wiring line 117α is changed. Further, repetitive descriptions of structures, actions, and effects similar to those of the first embodiment described above will be omitted.

As illustrated in FIG. 9, the first common wiring line 117α according to the present embodiment is configured to include a portion formed from a portion of the third metal film and a portion formed from a portion of the second metal film. More specifically, the first common wiring line 117α includes an overlapping portion 141 formed from a portion of the third metal film, a lead-out portion 43 formed from a portion of the third metal film and led out from the overlapping portion 141, and a connection portion 44 formed from a portion of the second metal film and connected to the lead-out portion 43. As in the first embodiment, the overlapping portion 141 is disposed to overlap a portion of a first source wiring line 127α that does not overlap a second upper face 134B1 of a first high level portion 134B. In addition, as in the first embodiment, two overlapping portions 141 are disposed at positions where the first high level portion 134B (connection portion 44) is interposed in the Y-axis direction.

As illustrated in FIG. 9, the lead-out portion 43 is a portion of the first common wiring line 117α that protrudes laterally from the first source wiring line 127α. More specifically, two lead-out portions 43 are provided to be continuous with each end portion of each of the overlapping portions 141 on the first high level portion 134B side. The two lead-out portions 43 are led out laterally from each end portion of each of the overlapping portions 141 so as not to overlap the first source wiring line 127α. The lead-out portion 43 extends from the end portion of the overlapping portion 141 along the outward shape of the first high level portion 134B, and has a substantially arcuate shape in a plan view. The lead-out portion 43 is disposed at a position where it does not overlap either the first source wiring line 127α or the second upper face 134B1 of the first high level portion 134B.

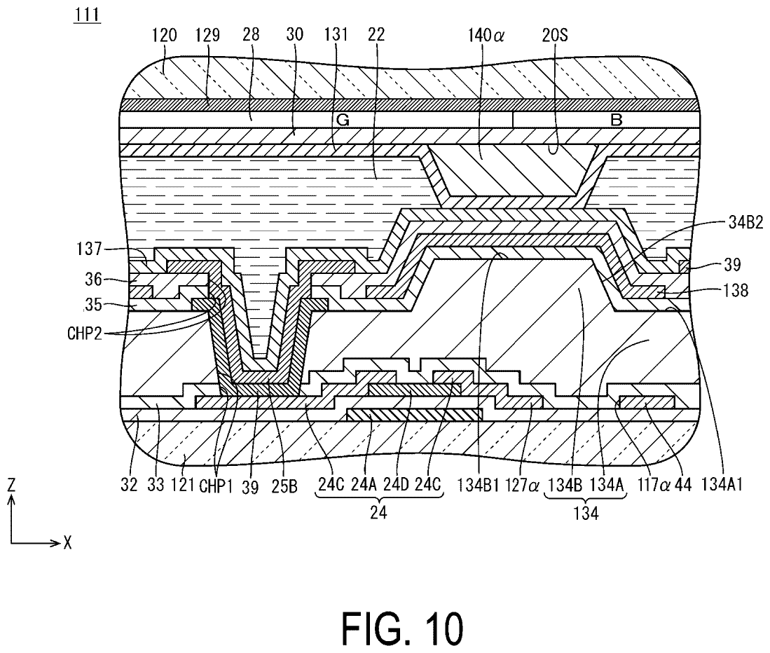

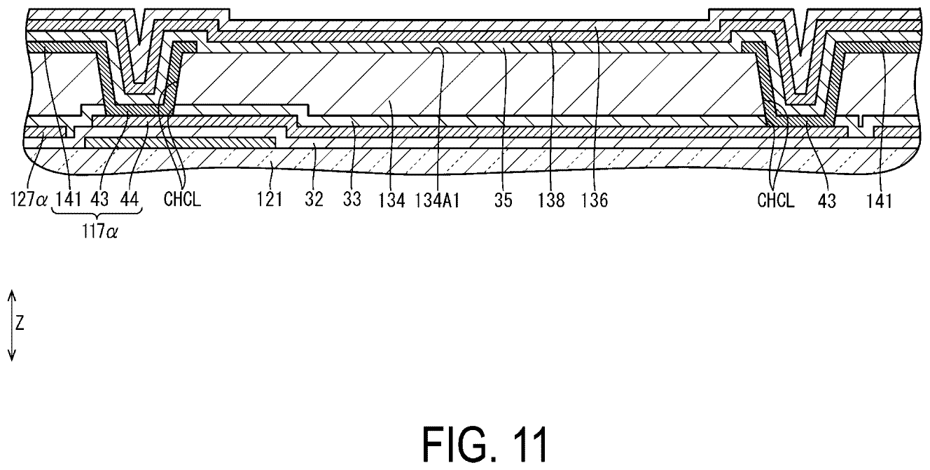

As illustrated in FIGS. 9 and 10, the connection portion 44 is a portion of the first common wiring line 117α that protrudes laterally from the first source wiring line 127α similarly to the above-described lead-out portion 43. More specifically, the connection portion 44 formed from a portion of the second metal film is disposed at a position spaced apart in the X-axis direction from the first source wiring line 127α formed from the same portion of the second metal film. This prevents the first common wiring line 117α and the first source wiring line 127α from being short-circuited. The connection portion 44 is formed as a planar shape curved to bypass the first high level portion 134B. The connection portion 44 extends along the outward shape of the first high level portion 134B and has a substantially semicircular arc shape in a plan view. The connection portion 44 is disposed so that both ends thereof overlap (a portion of) each lead-out tip portion of the two lead-out portions 43 from the overlapping portion 141. As illustrated in FIG. 11, a common wiring line contact hole (contact hole) CHCL is provided as an opening in a first interlayer insulating film 133 and a first flattening film 134 interposed between the lead-out portion 43 and the connection portion 44 overlapping each other at a position overlapping the lead-out portion 43 and the connection portion 44. The connection portion 44 formed from a portion of the second metal film is connected to the lead-out portion 43 formed from a portion of the third metal film through the common wiring line contact hole CHCL.

In this way, the overlapping portion 141 and the lead-out portion 43, each being formed from a portion of the third metal film of the first common wiring line 117α, are disposed not to overlap the second upper face 134B1 of the first high level portion 134B, which makes it possible to prevent local unevenness caused by the first common wiring line 117α from occurring on the second upper face 134B1 of the first high level portion 134B. This ensures a sufficient contact area between a portion of a first alignment film 131 overlapping a first spacer 140α that constitutes the surface of a counter substrate 120 facing an array substrate 121 and a portion of a second alignment film 137 overlapping the first high level portion 134B that constitutes the surface of the array substrate 121 facing the counter substrate 120, which makes it less likely that dust will be generated on each alignment films 131 and 137 due to their wear and increases the certainty that a function of holding the distance between the counter substrate 120 and the array substrate 121 will be appropriately performed. When the generation of dust on each of the alignment films 131 and 137 is suppressed, the light-blocking range of a light blocking portion 129 near the first spacer 140α and the first high level portion 134B can be narrowed, which makes it possible to increase the aperture ratio of the pixel PX. In this way, the overlapping portion 141 of the first common wiring line 117α can be disposed to overlap the first source wiring line 127α which is in an overlapping relationship with the first spacer 140α and the first high level portion 134B, and thus the number of first common wiring lines 117α installed can be increased compared to the known case in which the spacer and the high level portion are disposed not to overlap the wiring line. In the present embodiment, the common wiring line 117 is disposed to overlap all the source wiring lines 127. That is, the number of common wiring lines 117 installed is equal to the number of source wiring lines 127 installed, and the number of common wiring lines 117 installed is maximized without lowering the aperture ratio of the pixel PX. This is suitable for reducing the resistance distribution of a common electrode 138.

Moreover, the connection portion 44 formed from a portion of the second metal film is disposed to bypass the first high level portion 134B and does not overlap the second upper face 134B1, which makes it possible to prevent local unevenness caused by the connection portion 44 from occurring on the second upper face 134B1 of the first high level portion 134B.

As described above, the liquid crystal panel 111 of the present embodiment includes the counter substrate 120, the array substrate 121 facing the counter substrate 120 with an interval therebetween, the first spacer 140α provided on the counter substrate 120 and protruding from the counter substrate 120 toward the array substrate 121, the first source wiring line 127α provided on the array substrate 121 and formed from a portion of the second metal film, the flattening film 134 provided on the array substrate 121 and disposed on the upper layer side of the second metal film, and the first common wiring line 117α provided on the array substrate 121 and including a portion formed from a portion of the third metal film disposed on the upper layer side of the flattening film 134 and a portion formed from a portion of the second metal film, in which the flattening film 134 includes a low level portion 134A including a first upper face 134A1 as its upper face, and the first high level portion 134B protruding from the first upper face 134A1 toward the counter substrate 120 and including the second upper face 134B1 higher than the first upper face 134A1 as its upper face, the first high level portion 134B overlaps the first spacer 140α and is disposed to overlap a portion of the first source wiring line 127α, the first common wiring line 117α includes the overlapping portion 141 formed from a portion of the third metal film and overlapping a portion of the first source wiring line 127α that does not overlap the second upper face 134B1, the lead-out portion 43 formed from a portion of the third metal film, led out from the overlapping portion 141, and disposed at a position that does not overlap the first source wiring line 127α and the second upper face 134B1, and the connection portion 44 formed from a portion of the second metal film and disposed to overlap a portion of the lead-out portion 43, and the common wiring line contact hole (contact hole) CHCL that connects the lead-out portion 43 and the connection portion 44 is provided at a position of the flattening film 134 that overlaps both the lead-out portion 43 and the connection portion 44.

The first spacer 140α protruding from the counter substrate 120 toward the array substrate 121 is configured to be able to contact a portion of the surface of the array substrate 121 facing the counter substrate 120 that overlaps the first high level portion 134B of the flattening film 134. This allows the distance (cell gap) between the counter substrate 120 and the array substrate 121 facing each other to be reliably held. The overlapping portion 141 of the first common wiring line 117α is formed from a portion of the third metal film and overlaps a portion of the first source wiring line 127α formed from a portion of the second metal film that does not overlap the second upper face 134B1, and thus the aperture ratio is less likely to decrease due to the first common wiring line 117α. The overlapping portion 141 and the first source wiring line 127α are maintained in an insulated state by the flattening film 134. The lead-out portion 43 led out from the overlapping portion 141 is disposed at a position that does not overlap the first source wiring line 127α and the second upper face 134B1, and the connection portion 44 is disposed to overlap a portion thereof. The lead-out portion 43 formed from a portion of the third metal film and the connection portion 44 formed from a portion of the second metal film are connected to each other through the common wiring line contact hole CHCL in which their overlapping portion is provided in the flattening film 134. In this way, the overlapping portion 141 and the lead-out portion 43, each being formed from a portion of the third metal film of the first common wiring line 117α, are disposed not to overlap the second upper face 134B1 of the first high level portion 134B, which makes it possible to prevent local unevenness caused by the first common wiring line 117α from occurring on the second upper face 134B1 of the first high level portion 134B. This ensures a sufficient contact area between a portion of the surface of the counter substrate 120 facing the array substrate 121 that overlaps the first spacer 140α and a portion of the surface of the array substrate 121 facing the counter substrate 120 that overlaps the first high level portion 134B, which makes it less likely that dust will be generated due to their wear and increases the certainty that a function of holding the distance between the counter substrate 120 and the array substrate 121 will be appropriately performed. In this way, the overlapping portion 141 of the first common wiring line 117α can be disposed to overlap the first source wiring line 127α which is in an overlapping relationship with the first spacer 140α and the first high level portion 134B, and thus the number of first common wiring lines 117α installed can be increased compared to the known case in which the spacer and the high level portion are disposed not to overlap the wiring line.

In addition, the connection portion 44 is disposed to bypass the first high level portion 134B and does not overlap the second upper face 134B1. The connection portion 44 formed from a portion of the second metal film is disposed to bypass the first high level portion 134B and does not overlap the second upper face 134B1, which makes it possible to prevent local unevenness caused by the connection portion 44 from occurring on the second upper face 134B1 of the first high level portion 134B.

### Third Embodiment

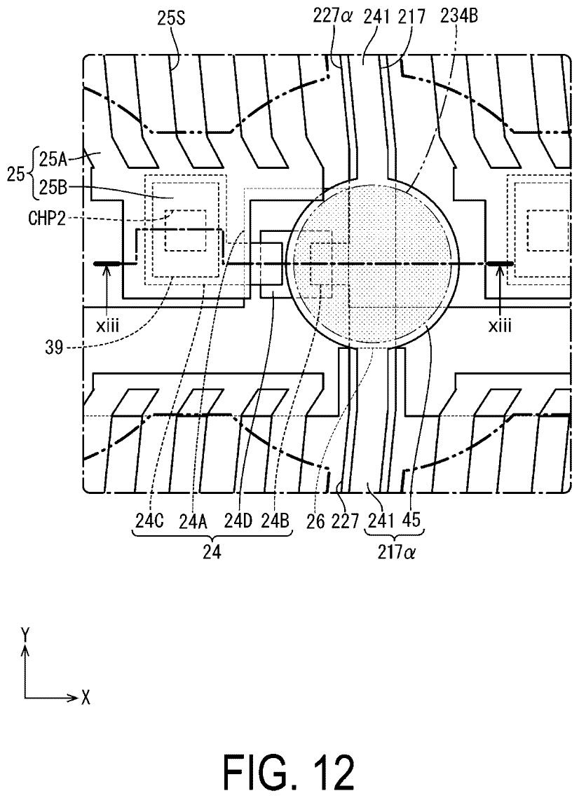

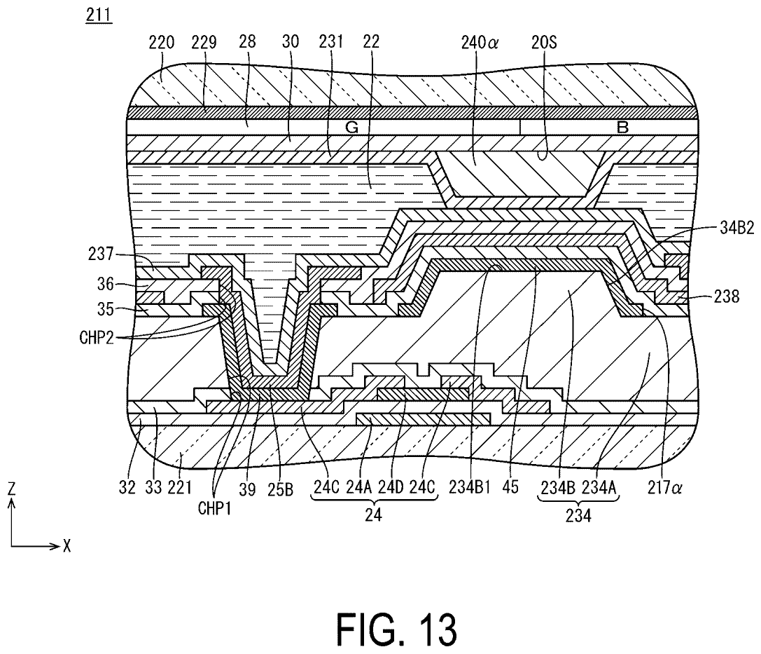

A third embodiment will be described with reference to FIG. 12 and FIG. 13. In this third embodiment, a case in which the configuration of the first common wiring line 217α is changed from the first embodiment described above will be illustrated. Further, repetitive descriptions of structures, actions, and effects similar to those of the first embodiment described above will be omitted.

As illustrated in FIGS. 12 and 13, the first common wiring line 217α according to the present embodiment has an overlapping portion 241 formed from a portion of the third metal film and a covering portion 45 formed from a portion of the third metal film and continuous with the overlapping portion 241. As in the first embodiment, the overlapping portion 241 constituting the first common wiring line 217α is disposed to overlap a portion of a first source wiring line 227α that does not overlap a second upper face 234B1 of a first high level portion 234B. In addition, as in the first embodiment, two overlapping portions 241 are disposed at positions where the first high level portion 234B (the covering portion 45) is interposed in the Y-axis direction.

The covering portion 45 is wider than the overlapping portion 241 and is disposed to overlap the first source wiring line 227a and also overlap the second upper face 234B1 of the first high level portion 234B. The covering portion 45 has a substantially circular shape in a plan view, and its diameter is the same as or slightly larger than the diameter of the first high level portion 234B. The covering portion 45 is disposed over almost the entire area of the second upper face 234B1, and covers the second upper face 234B1. The covering portion 45 has a portion of its outer peripheral end portion connected to each end portion of the two overlapping portions 241. In this way, the first common wiring line 217α is formed with a locally increased width so as to overlap the entire area of the second upper face 234B1 of the first high level portion 234B.

In this way, the first common wiring line 217α has the covering portion 45 which is continuous with the overlapping portion 241 and covers the second upper face 234B1, which makes it possible to prevent local unevenness caused by the first common wiring line 217α from occurring on the second upper face 234B1 of the first high level portion 234B. This ensures a sufficient contact area between a portion of a first alignment film 231 overlapping a first spacer 240α that constitutes the surface of a counter substrate 220 facing an array substrate 221 and a portion of a second alignment film 237 overlapping the first high level portion 234B that constitutes the surface of an array substrate 221 facing the counter substrate 220, which makes it less likely that dust will be generated on each of the alignment films 231 and 237 due to their wear and increases the certainty that a function of holding the distance between the counter substrate 220 and the array substrate 221 will be appropriately performed. When the generation of dust on each of the alignment films 231 and 237 is suppressed, the light-blocking range of a light blocking portion 229 near the first spacer 240α and the first high level portion 234B can be narrowed, which makes it possible to increase the aperture ratio of the pixel PX. In this way, the overlapping portion 241 of the first common wiring line 217α can be disposed to overlap the first source wiring line 227α which is in an overlapping relationship with the first spacer 240α and the first high level portion 234B, and thus the number of first common wiring lines 217α installed can be increased compared to the known case in which the spacer and the high level portion are disposed not to overlap the wiring line. In the present embodiment, the common wiring line 217 is disposed to overlap all the source wiring lines 227. That is, the number of common wiring lines 217 installed is equal to the number of source wiring lines 227 installed, and the number of common wiring lines 217 installed is maximized without lowering the aperture ratio of the pixel PX. This is suitable for reducing the resistance distribution of a common electrode 238.

As described above, the liquid crystal panel 211 of the present embodiment includes the counter substrate 220, the array substrate 221 facing the counter substrate 220 with an interval therebetween, the first spacer 240α provided on the counter substrate 220 and protruding from the counter substrate 220 toward the array substrate 221, the first source wiring line 227a provided on the array substrate 221 and formed from a portion of the second metal film, a flattening film 234 provided on the array substrate 221 and disposed on the upper layer side of the second metal film, and the first common wiring line 217α provided on the array substrate 221 and formed from a portion of the third metal film disposed the upper layer side of the flattening film 234, in which the flattening film 234 includes a low level portion 234A including a first upper face 234A1 as its upper face, and the first high level portion 234B protruding from the first upper face 234A1 toward the counter substrate 220 and including the second upper face 234B1 higher than the first upper face 234A1 as its upper face, the first high level portion 234B is disposed to overlap the first spacer 240α and overlap a portion of the first source wiring line 227α, and the first common wiring line 217α includes the overlapping portion 241 overlapping a portion of the first source wiring line 227α that does not overlap the second upper face 234B1, and the covering portion 45 which is continuous with the overlapping portion 241 and covers the second upper face 234B1.

The first spacer 240α protruding from the counter substrate 220 toward the array substrate 221 is configured to be able to contact a portion of the surface of the array substrate 221 facing the counter substrate 220 that overlaps the first high level portion 234B of the flattening film 234. This allows the distance (cell gap) between the counter substrate 220 and the array substrate 221 facing each other to be reliably held. The first common wiring line 217α formed from a portion of the third metal film has the overlapping portion 241 that overlaps a portion of the first source wiring line 227α formed from a portion of the second metal film that does not overlap the second upper face 234B1, and thus the aperture ratio is less likely to decrease due to the first common wiring line 217α. The overlapping portion 241 and the first source wiring line 227α are maintained in an insulated state by the flattening film 234. The first common wiring line 217α has the covering portion 45 which is continuous with the overlapping portion 241 and covers the second upper face 234B1, which makes it possible to prevent local unevenness caused by the first common wiring line 217α from occurring on the second upper face 234B1 of the first high level portion 234B. This ensures a sufficient contact area between a portion of the surface of the counter substrate 220 facing the array substrate 221 that overlaps the first spacer 240α and a portion of the surface of the array substrate 221 facing the counter substrate 220 that overlaps the first high level portion 234B, which makes it less likely that dust will be generated due to their wear and increases the certainty that a function of holding the distance between the counter substrate 220 and the array substrate 221 will be appropriately performed. In this way, the overlapping portion 241 of the first common wiring line 217α can be disposed to overlap the first source wiring line 227α which is in an overlapping relationship with the first spacer 240α and the first high level portion 234B, and thus the number of first common wiring lines 217α installed can be increased compared to the known case in which the spacer and the high level portion are disposed not to overlap the wiring line.

### Fourth Embodiment

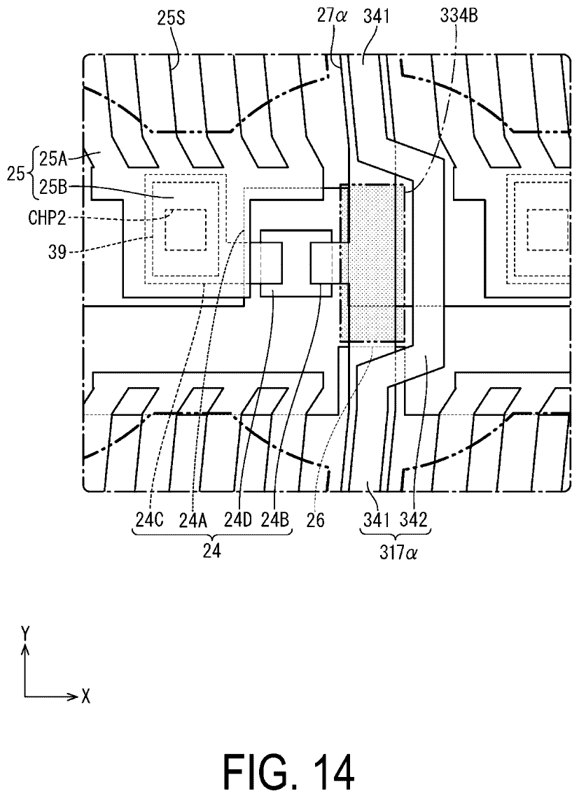

A fourth embodiment will be described with reference to FIG. 14. In this fourth embodiment, a case in which the configurations of a first high level portion 334B and a first common wiring line 317α are changed from the first embodiment described above will be illustrated. Further, repetitive descriptions of structures, actions, and effects similar to those of the first embodiment described above will be omitted.

As illustrated in FIG. 14, the first high level portion 334B according to the present embodiment has a vertically elongated and substantially rectangular shape in a plan view. Meanwhile, although not illustrated, the planar shape of the first spacer 40α overlapping the first high level portion 334B is a vertically elongated and substantially rectangular shape similarly to the first high level portion 334B. The first common wiring line 317α is provided such that a non-overlapping portion 342 continuous with the end portion of an overlapping portion 341 bypasses the first high level portion 334B and extends along the outward shape of the first high level portion 334B. Specifically, the non-overlapping portions 342 are led out laterally from each end portion of the two overlapping portions 341 in oblique directions inclined with respect to the X-axis direction and the Y-axis direction, and then extend almost straight in the Y-axis direction. With such a configuration, it is also possible to obtain the same actions and effects as those of the first embodiment described above.

### Fifth Embodiment

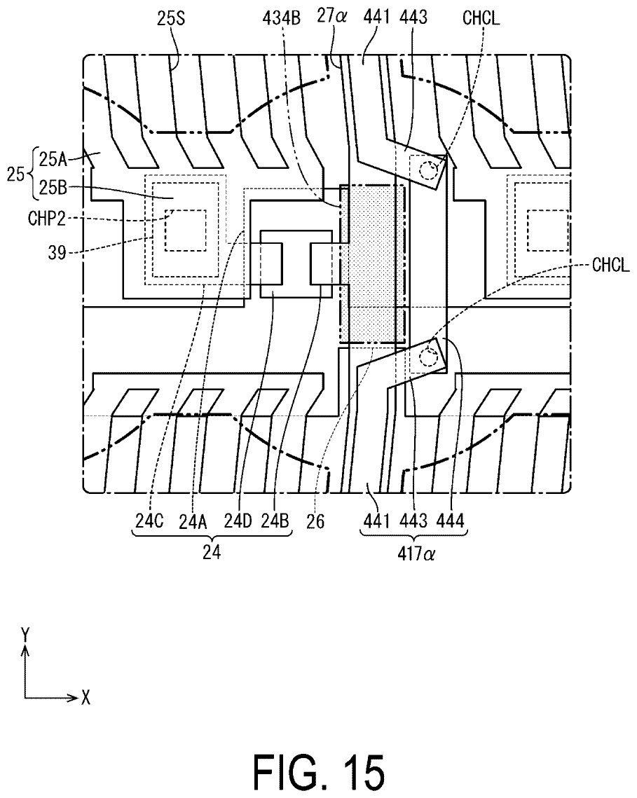

A fifth embodiment will be described with reference to FIG. 15. In this fifth embodiment, a case in which the configurations of a first high level portion 434B and a first common wiring line 417α are changed from the second embodiment described above will be illustrated. Further, repetitive descriptions of structures, actions, and effects similar to those of the second embodiment described above will be omitted.

As illustrated in FIG. 15, the first high level portion 434B according to the present embodiment has a vertically elongated and substantially rectangular shape in a plan view. Meanwhile, although not illustrated, the planar shape of the first spacer 40α overlapping the first high level portion 434B is a vertically elongated and substantially rectangular shape similarly to the first high level portion 434B. The first common wiring line 417α is provided such that a lead-out portion 443 continuous with the end portion of an overlapping portion 441 and a connection portion 444 formed from a portion of the second metal film bypass the first high level portion 434B and extend along the outward shape of the first high level portion 434B. Specifically, the lead-out portions 443 are led out laterally from each end portion of two overlapping portions 441 in oblique directions inclined with respect to the X-axis direction and the Y-axis direction. The connection portion 444 extends almost straight in the Y-axis direction, and both ends thereof are disposed to overlap the lead-out tip portions of the two lead-out portions 443 and are connected through the common wiring line contact hole CHCL. With such a configuration, it is also possible to obtain the same actions and effects as those of the first embodiment described above.

### Sixth Embodiment

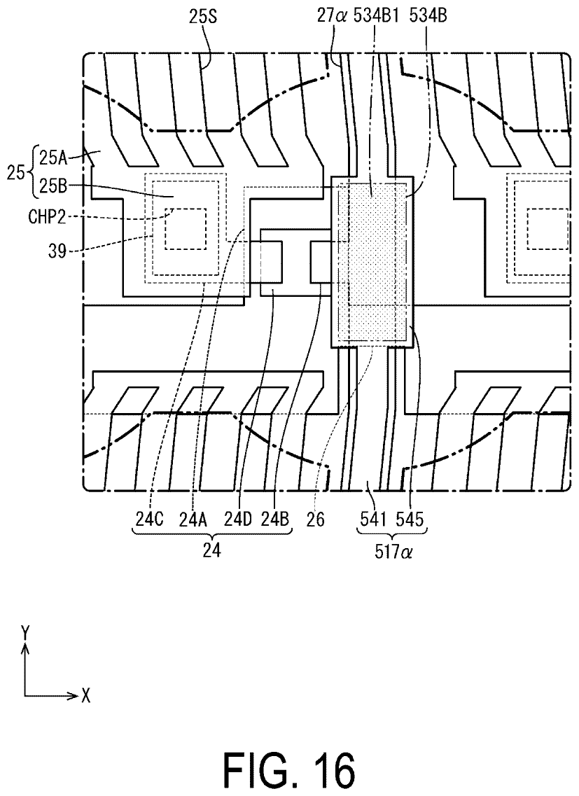

A sixth embodiment will be described with reference to FIG. 16. In this sixth embodiment, the configurations of a first high level portion 534B and a first common wiring line 517α are changed from the third embodiment described above will be illustrated. Note that redundant descriptions of structures, actions, and effects similar to those of the third embodiment described above will be omitted.

As illustrated in FIG. 16, the first high level portion 534B according to the present embodiment has a vertically elongated and substantially rectangular shape in a plan view. Meanwhile, although not illustrated, the planar shape of the first spacer 40α overlapping the first high level portion 534B is a vertically elongated and substantially rectangular shape similarly to the first high level portion 534B. In the first common wiring line 517α, an overlapping portion 541 has a vertically elongated and substantially rectangular shape in a plan view. More specifically, a covering portion 545 is wider than the overlapping portion 541, and its width dimension and length dimension are the same as or slightly larger than the width dimension and length dimension of the first high level portion 534B. The covering portion 545 is disposed over almost the entire area of a second upper face 534B1 of the first high level portion 534B, and covers the second upper face 534B1. With such a configuration, it is also possible to obtain the same actions and effects as those of the first embodiment described above.

### Seventh Embodiment

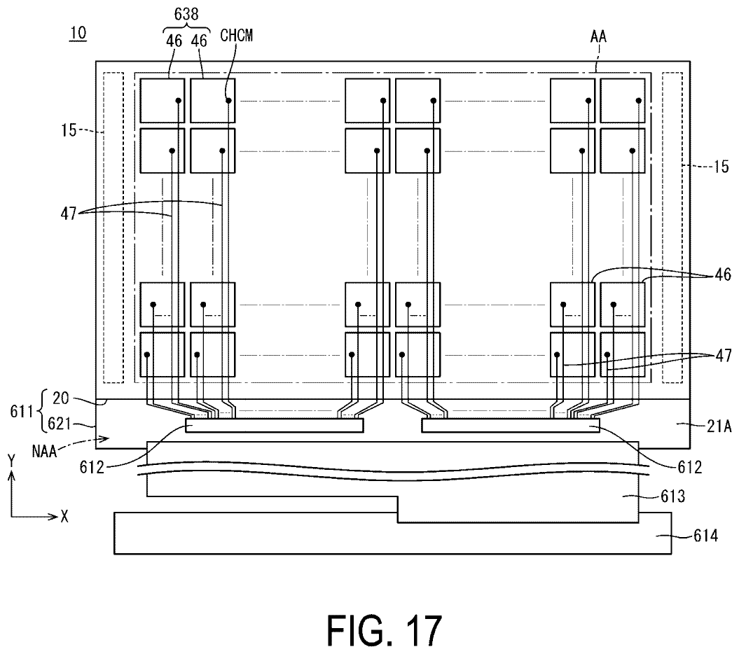

A seventh embodiment will be described with reference to FIG. 17. In this seventh embodiment, a case in which a touch panel function is added to a liquid crystal panel 611 from the first embodiment described above will be illustrated. Further, repetitive descriptions of structures, actions, and effects similar to those of the first embodiment described above will be omitted.

The liquid crystal panel 611 according to the present embodiment has both a display function of displaying an image and a touch panel function of detecting a position (input position) at which a user makes an input on the basis of the displayed image. The liquid crystal panel 611 is integrated (in-cell) with a touch panel pattern for realizing the touch panel function. The touch panel pattern is a so-called projected electrostatic capacitance type, and the detection type thereof is a self-capacitance type. As illustrated in FIG. 17, the touch panel pattern is constituted by a plurality of touch electrodes (position detection electrodes) 46 disposed side by side in a matrix shape within the display region AA of the liquid crystal panel 611. The display region AA of the liquid crystal panel 611 substantially coincides with the touch region (position input region) where an input position can be detected, and the non-display region NAA substantially coincides with the non-touch region (non-position input region) where an input position cannot be detected. When a user attempts to input a position on the basis of an image in the display region AA of the liquid crystal panel 611 to be visually recognized and brings a conductive finger (position input object) close to the surface of the liquid crystal panel 611, electrostatic capacitance is formed between the finger and a touch electrode 46. As a result, the electrostatic capacitance detected by the touch electrode 46 near the finger changes as the finger approaches, and becomes different from that of the touch electrode 46 farther away from the finger, which makes it possible to detect the input position on the basis of this. The touch electrode 46 has a substantially rectangular shape in a plan view, with each side measuring approximately several mm. Therefore, the touch electrode 46 has a size in a plan view which is much larger than a pixel to be described later, and is disposed over a range spanning a plurality of pixels in both the X-axis direction and the Y-axis direction. The touch electrode 46 having such a configuration is constituted by a common electrode 638. The common electrode 638 has lattice-patterned partition slits that partition the touch electrodes 46 adjacent to each other. The common electrode 638 is divided into a grid pattern by the partition slits to constitute a plurality of touch electrodes 46 which are electrically independent of one another. Meanwhile, in addition to those illustrated in FIG. 17, the specific number of touch electrodes 46 installed and their planar shapes can be appropriately changed.

On the inner face side of an array substrate 621 in the display region AA, a touch wiring line (position detection wiring line) 47 connected to the touch electrode 46 is provided instead of the common wiring line 17 described in the first embodiment described above. Similarly to the common wiring line 17, the touch wiring line 47 extends in the Y-axis direction so as to cross the display region AA, and is parallel to the source wiring line 27 and disposed to overlap the source wiring line 27 (see FIG. 3). A plurality of touch wiring lines 47 are disposed side by side with intervals therebetween in the X-axis direction in the display region AA. At least one touch wiring line 47 is connected to the touch electrode 46. A common potential signal related to the display function and a touch signal (position detection signal) related to the touch function are supplied to the touch wiring line 47 at different timings (in a time-division manner). The timing at which the common potential signal is supplied to the touch wiring line 47 is a display period, and the timing at which the touch signal is supplied to the touch wiring line 47 is a sensing period (position detection period). During the display period, the common potential signal is supplied to all the touch wiring lines 47, and thus all the touch electrodes 46 serve as a common potential and function as the common electrode 638. The touch wiring line 47 is connected to a driver 612. The touch signal and the common potential signal are supplied from the driver 612 to the touch wiring line 47. Meanwhile, the touch wiring line 47 may be connected to a flexible substrate 613, in which case the touch signal and the common potential signal are supplied from a control substrate 614 through the flexible substrate 613 to the touch wiring line 47.

The touch wiring line 47 includes a first touch wiring line (second wiring line) 47 which is in an overlapping relationship with the first source wiring line 27α (the source wiring line 27 which is in an overlapping relationship with the first high level portion 34B and the first spacer 40α) (see FIG. 3). Similarly to the first common wiring line 17 described in the first embodiment, the first touch wiring line 47 includes the overlapping portion 41 overlapping a portion of the first source wiring line 27α that does not overlap the second upper face 34B1, and the non-overlapping portion 42, continuous with the overlapping portion 41, which is disposed to bypass the first high level portion 34B and does not overlap the second upper face 34B1 (see FIG. 8). This makes it possible to obtain the same actions and effects as those of the first embodiment described above. In particular, in the present embodiment, a large number of touch wiring lines 47 can be installed, which is suitable for reducing the resistance distribution of the touch electrodes 46.

### Other Embodiments

The techniques disclosed herein are not limited to the embodiments described above and illustrated in the drawings, and the following embodiments, for example, are also included within the technical scope.
(1) The non-overlapping portions 42 and 342, the connection portions 44 and 444, or the covering portions 45 and 545 provided in the first common wiring lines 17α, 117α, 217α, 317α, 417α, and 517α or the first touch wiring line 47 may be disposed on the side surface 34B2 of the first high level portions 34B, 134B, 234B, 334B, 434B, and 534B. With such a configuration, it is also possible to prevent local unevenness caused by the first common wiring lines 17α, 117α, 217α, 317α, 417α, and 517α or the first touch wiring line 47 from occurring on the second upper faces 34B1, 134B1, 234B1, and 534B1 of the first high level portions 34B, 134B, 234B, 334B, 434B, and 534B.
(2) The number of first source wiring lines 27α, 127α, and 227α included in the source wiring lines 27, 127, and 227 (the number of first common wiring lines 17α, 117α, 217α, 317α, 417α, and 517α or first touch wiring lines 47 included in the common wiring lines 17, 117, and 217 or the touch wiring line 47) can change depending on the number and arrangement of first spacers 40α, 140α, and 240α and first high level portions 34B, 134B, 234B, 334B, 434B, and 534B, and in some cases, all the source wiring lines 27, 127, and 227 may become the first source wiring lines 27α, 127, and 227α (all the common wiring lines 17, 117, and 217 or the touch wiring line 47 may become the first common wiring lines 17α, 117α, 217α, 317α, 417α, and 517α or the first touch wiring line 47).
(3) A plurality of first spacers 40α, 140α, and 240α and plurality of first high level portions 34B, 134B, 234B, 334B, 434B, and 534B may be disposed to overlap for each of the first source wiring lines 27α, 127α, and 227α. In that case, the first common wiring lines 17α, 117α, 217α, 317α, 417α, and 517α or the first touch wiring line 47 is configured to have three or more overlapping portions 41, 141, 241, 341, 441, and 541, and to have a plurality of non-overlapping portions 42 and 342, connection portions 44 and 444, or covering portions 45 and 545.
(4) In the configurations described in the first and fourth embodiments, the non-overlapping portions 42 and 342 may extend not to be along the outward shape of first high level portions 34B and 334B. That is, the planar shape of the non-overlapping portions 42 and 342 may not coincide with the outward shape of the first high level portions 34B and 334B.
(5) In the configurations described in the first and fourth embodiments, the non-overlapping portions 42 and 342 may be in an overlapping relationship with the source electrode 24B or the semiconductor portion 24D of the TFT 24 (a positional relationship in which these portions are disposed on the left side in FIGS. 8 and 14 relative to the first high level portions 34B and 334B).
(6) In the configuration described in the second and fifth embodiments, the connection portions 44 and 444 may be in a relationship in which a portion or all thereof overlaps the second upper face 134B1 of the first high level portion 134B, 434B. The connection portions 44 and 444 are formed from a portion of the second metal film and are located on the lower layer side of the flattening film 34, and thus even when the connection portions are in an overlapping relationship with the second upper face 134B1, the possibility of causing local unevenness on the second upper face 134B1 is sufficiently low.
(7) In the configurations described in the third and sixth embodiments, the covering portions 45 and 545 may be provided in a range that covers not only the second upper faces 234B1 and 534B1 of the first high level portions 234B and 534B but also the side surface 34B2.
(8) The configuration described in the seventh embodiment can also be combined with the configurations described in the second to sixth embodiments. In a case where the configuration described in the seventh embodiment is combined with the configurations described in the second and fifth embodiments, the touch wiring line 47 includes the overlapping portions 141 and 441, the lead-out portions 43 and 443, and the connection portions 44 and 444. In a case where the configuration described in the seventh embodiment is combined with the configurations described in the third and sixth embodiments, the touch wiring line 47 includes the overlapping portions 241 and 541 and the covering portions 45 and 545.
(9) The number of common wiring lines 17, 117, and 217 or touch wiring lines 47 installed may be less than the number of source wiring lines 27, 127, and 227 installed.
(10) The first high level portions 34B, 134B, 234B, 334B, 434B, and 534B and the first spacers 40α, 140α, and 240α may be in a partially overlapping relationship. Similarly, the second high level portion 34C and the second spacer 40β may be in a partially overlapping relationship.
(11) The specific planar arrangement of each of the high level portions 34B, 34C, 134B, 234B, 334B, 434B, and 534B and each of the spacers 40α, 40β, 140α, and 240α in the display region AA of the array substrates 21, 121, 221, and 621 can be appropriately changed in various ways other than those illustrated in the drawings. In that case, it is also preferable that each of the high level portions 34B, 34C, 134B, 234B, 334B, 434B, and 534B and each of the spacers 40α, 40β, 140α, and 240α are in an overlapping relationship with at least the light blocking portions 29, 129, and 229 of the counter substrates 20, 120, and 220 in order to maintain a high aperture ratio of the pixel PX.
(12) The specific planar arrangement of the TFTs 24 in the display region AA of the array substrates 21, 121, 221, and 621 can be appropriately changed in various ways other than those illustrated in the drawings. For example, all the TFTs 24 may be connected to the pixel electrode 25 on one side in the X-axis direction (the left side in FIG. 3) with respect to the source wiring lines 27, 127, and 227 to be connected, or all the TFTs 24 may be connected to the pixel electrode 25 on the other side in the X-axis direction (the right side in FIG. 3) with respect to the source wiring lines 27, 127, and 227 to be connected.
(13) The formation range and arrangement of the second high level portion 34C and the second spacer 40β in a plan view can be appropriately changed in various ways other than those illustrated in the drawings. For example, the second high level portion 34C and the second spacer 40β may be disposed in a dot-like manner near the intersections between the gate wiring line 26 and the source wiring lines 27, 127, and 227, similarly to the first high level portions 34B, 134B, 234B, 334B, 434B, and 534B and the first spacers 40α, 140α, and 240α.
(14) The second common wiring line 178 may have the same configuration as the first common wiring lines 17α, 117α, 217α, 317α, 417α, and 517α. For example, as in the first and fourth embodiments, the second common wiring line 178 may include the overlapping portions 41, 141, 241, 341, 441, and 541 overlapping portions of the second source wiring line 27β that do not overlap the third upper face 34C1, and the non-overlapping portions 42 and 342, continuous with the overlapping portions 41, 141, 241, 341, 441, and 541, which are disposed to bypass the second high level portion 34C and do not overlap the third upper face 34C1. In addition, as in the second and fifth embodiments, the second common wiring line 17 may include the overlapping portions 41, 141, 241, 341, 441, and 541, the lead-out portions 43 and 443 which are led out from the overlapping portions 41, 141, 241, 341, 441, and 541 and disposed at positions that do not overlap the second source wiring line 273 and the third upper face 34C1, and the connection portions 44 and 444 which are formed from a portion of the second metal film and disposed to overlap a portion of the lead-out portions 43 and 443. In addition, as in the third and sixth embodiments, the second common wiring line 17β may include the overlapping portions 41, 141, 241, 341, 441, and 541, and the covering portions 45 and 545 which are continuous with the overlapping portions 41, 141, 241, 341, 441, and 541 and cover the third upper face 34C1.
(15) The first spacers 40α, 140α, and 240α may have the same height as the second spacer 40β. In that case, the height of the first high level portions 34B, 134B, 234B, 334B, 434B, and 534B needs only to be set to be greater than the height of the second high level portion 34C.
(16) The second high level portion 34C may be lower than the first high level portions 34B, 134B, 234B, 334B, 434B, and 534B. In that case, the third upper face 34C1 may be disposed lower than the second upper faces 34B1, 134B1, 234B1, and 534B1.
(17) The source wiring lines 27, 127, and 227 and the common wiring lines 17, 117, and 217 (touch wiring line 47) may extend almost straight in the Y-axis direction. In that case, the main body portion 25A of the pixel electrode 25 also has a substantially straight planar shape in the Y-axis direction. In addition, the color filter 28 is also configured to extend almost straight in the Y-axis direction.
(18) It is also possible to omit the first interlayer insulating film 33 in the array substrates 21, 121, 221, and 621.
(19) A gate driver may be mounted on the array substrates 21, 121, 221, and 621 instead of the gate drive circuit 15.
(20) The material of the semiconductor film provided on the array substrates 21, 121, 221, and 621 may be a polycrystalline polysilicon material or the like.
(21) The number and arrangement of drivers 12 and 612 can be appropriately changed in various ways other than those illustrated in the drawings.
(22) In the display region AA, the light blocking portions 29, 129, and 229 may be in the form of stripes extending in the Y-axis direction.
(23) The pixel electrode 25 may be located on the lower layer side with respect to the third interlayer insulating film 36, and the common electrodes 38, 138, 238, and 638 may be located on the upper layer side with respect to the third interlayer insulating film 36. In that case, it is preferable to form slits for orientation control in the common electrodes 38, 138, 238, and 638.
(24) The planar shape of the liquid crystal panels 11, 111, and 211 may be a vertically elongated rectangle, square, circle, semicircle, oval, ellipse, trapezoid, or the like.
(25) The liquid crystal panels 11, 111, and 211 may be a semi-transmissive type or a reflective type, in addition to a transmissive type.
(26) The display mode of the liquid crystal panels 11, 111, and 211 may be a multi-domain vertical alignment (MVA) mode, an in-plane switching (IPS) mode, a twisted nematic (TN) mode, or the like, in addition to an FFS mode.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display device comprising:
a first substrate;
a second substrate facing the first substrate with an interval between the second substrate and the first substrate;
a first spacer provided on the first substrate and protruding from the first substrate toward the second substrate;
a first wiring line provided on the second substrate and formed from a portion of a first conductive film;
a first insulating film provided on the second substrate and disposed on an upper layer side of the first conductive film; and
a second wiring line provided on the second substrate and formed from a portion of a second conductive film disposed on an upper layer side of the first insulating film,
wherein the first insulating film includes a low level portion including a first upper face as an upper face of the low level portion, and a first high level portion protruding from the first upper face toward the first substrate and including a second upper face higher than the first upper face as an upper face of the first high level portion,
the first high level portion is disposed overlapping the first spacer and overlapping a portion of the first wiring line, and
the second wiring line includes an overlapping portion overlapping a portion of the first wiring line that does not overlap the second upper face, and a non-overlapping portion that is continuous with the overlapping portion and is disposed bypassing the first high level portion and not overlapping the second upper face.

2. The display device according to claim 1,
wherein the non-overlapping portion extends along an outward shape of the first high level portion.

3. The display device according to claim 1,
wherein the non-overlapping portion is disposed on the first upper face of the low level portion.

4. A display device comprising:
a first substrate;
a second substrate facing the first substrate with an interval between the second substrate and the first substrate;
a first spacer provided on the first substrate and protruding from the first substrate toward the second substrate;
a first wiring line provided on the second substrate and formed from a portion of a first conductive film;
a first insulating film provided on the second substrate and disposed on an upper layer side of the first conductive film; and
a second wiring line provided on the second substrate and including a portion formed from a portion of a second conductive film disposed on an upper layer side of the first insulating film and a portion formed from a portion of the first conductive film,
wherein the first insulating film includes a low level portion including a first upper face as an upper face of the low level portion, and a first high level portion protruding from the first upper face toward the first substrate and including a second upper face higher than the first upper face as an upper face of the first high level portion,
the first high level portion is disposed overlapping the first spacer and overlapping a portion of the first wiring line,
the second wiring line includes an overlapping portion formed from a portion of the second conductive film and overlapping a portion of the first wiring line that does not overlap the second upper face, a lead-out portion formed from a portion of the second conductive film, led out from the overlapping portion, and disposed at a position that does not overlap the first wiring line and the second upper face, and a connection portion formed from a portion of the first conductive film and disposed overlapping a portion of the lead-out portion, and
a contact hole connecting the lead-out portion and the connection portion is provided at a position overlapping both the lead-out portion and the connection portion within the first insulating film.

5. The display device according to claim 4,
wherein the connection portion is disposed bypassing the first high level portion and not overlapping the second upper face.

6. A display device comprising:
a first substrate;
a second substrate facing the first substrate with an interval between the second substrate and the first substrate;
a first spacer provided on the first substrate and protruding from the first substrate toward the second substrate;
a first wiring line provided on the second substrate and formed from a portion of a first conductive film;
a first insulating film provided on the second substrate and disposed on an upper layer side of the first conductive film; and
a second wiring line provided on the second substrate and formed from a portion of a second conductive film disposed on an upper layer side of the first insulating film,
wherein the first insulating film includes a low level portion including a first upper face as an upper face of the low level portion, and a first high level portion protruding from the first upper face toward the first substrate and including a second upper face higher than the first upper face as an upper face of the first high level portion,
the first high level portion is disposed overlapping the first spacer and overlapping a portion of the first wiring line, and
the second wiring line includes an overlapping portion overlapping a portion of the first wiring line that does not overlap the second upper face, and a covering portion that is continuous with the overlapping portion and covers the second upper face.

7. The display device according to claim 1, further comprising:
a second spacer provided on the first substrate and protruding from the first substrate toward the second substrate,
wherein the second spacer has a smaller projection dimension from the first substrate than the first spacer,
the first insulating film includes a second high level portion that protrudes from the first upper face toward the first substrate and includes a third upper face as an upper face of the second high level portion, the third upper face being higher than the first upper face and at the same height as the second upper face or lower than the second upper face,
the second high level portion overlaps the second spacer and overlaps a portion of the first wiring line, and
a portion of a surface of the first substrate facing the second substrate that overlaps the first spacer contacts a portion of a surface of the second substrate facing the first substrate that overlaps the first high level portion.
